(19) United States
(12) Patent Application Publication
(10) Pub. No.: US 2013/0040827 A1
(43) Pub. Date: Feb. 14, 2013

(54) METHOD AND COMPOSITIONS FOR DETECTING AND SEQUENCING NUCLEIC ACIDS

(71) Applicant: Stephen C. Macevicz, Cupertino, CA (US)

(72) Inventor: Stephen C. Macevicz, Cupertino, CA (US)

(21) Appl. No.: 13/584,819

(22) Filed: Aug. 13, 2012

Related U.S. Application Data
(60) Provisional application No. 61/523,376, filed on Aug. 14, 2011.

(51) Int. Cl. C40B 20/00; B82Y 15/00

(52) U.S. Cl. 506/2; 977/774; 977/902

(57) ABSTRACT

The invention is directed to methods of nucleic acid sequencing that use nanopores to detect and/or measure amounts of compounds, such as products or byproducts of nucleic acid sequencing reactions, and to the determination of a nucleotide sequence using such detection and/or measurement. The detection or measurements may employ products or byproducts having resistive-pulse labels, optical labels, or labels that are capable of generating both optical and resistive-pulse signals. Resistive-pulse labels are molecular labels bound or attached to an analyte which allows detection of the labeled analyte by a change in the electrical properties of a nanopore, such as trans-nanopore resistance. Labels for nanopore detection may also be optical labels, particularly acceptors of acceptor-donor pairs capable of undergoing fluorescent resonance energy transfer (FRET), where the donors are associated with, or label, a nanopore.

### BACKGROUND

DNA sequencing technologies developed in the last decade have revolutionized the biological sciences, e.g. Lemer et al. The Auk, 127:4-15 (2010); Metzket, Nature Review Genetics, 11:31-46 (2010); Holt et al. Genome Research. 18: 839-846 (2008). These advances also have the potential to revolutionize many aspect of medical practice, e.g. Voelkerding et al Clinical Chemistry, 55: 641-658 (2009); Anderson et al, Genes, 1: 38-69 (2010); Freeman et al, Genome Research, 19: 1817-1824 (2005)); Tucker et al, Am. J. Human Genet., 85: 142-1:54 (2009). To realize such potential there are still a host of challenges that must be addressed, including reduction of per-run sequencing cost, simplification of sample preparation, reduction of run time, improvement of data analysts, and the like, e.g. Baker, Nature Methods, 7: 495-498 (2010); Kircher et al, Bioessays, 32: 524-536 (2010); Turner et al. Annual Review of Genomics and Human Genetics, 10: 263-284 (2009).

In some forms, nanopore sequencing may address some of these challenges; for example, it may simplify sample preparation by not requiring template amplification for sequencing or it may provide an unprecedented speed of analysis. However, there are other technical challenges that have limited its implementation, e.g. Branton et al. Nature Biotechnology, 26(10): 1146-1153 (2008).

In view of the above, it would be advantageous for achieving DNA sequencing's potential, particularly in medical practice, to have available a system and method for DNA sequence analysis that combined advantages of amplification-based sequencing approaches with those of nanopore sequencing approaches.

### SUMMARY OF THE INVENTION

The present invention is directed to apparatus and methods for nucleic acid sequence analysis. The present invention is exemplified in a number of implementations and applications, some of which are summarized below and throughout the specification.

In some embodiments, the invention is directed to a method of determining a nucleotide sequence of a target polynucleotide comprising the steps of: (a) generating a plurality of amplicons from the target polynucleotide, each amplicon comprising multiple copies of a fragment of the target polynucleotide, (b) forming an array of amplicons on a nanopore array; (c) identifying a sequence of at least a portion of each fragment in the amplicons by repeatedly forming sequencing reaction products thereon labeled with one or more resistive-pulse labels and eluting the labeled sequencing reaction products through the nanopore array, where the number and type of sequencing reaction product for each amplicon is determined by a resistive-pulse signal; and (d) reconstructing the nucleotide sequence of the target polynucleotide from the identities of the sequences of the portions of fragments of the amplicons.

In some embodiments, the invention is directed to a method of determining a nucleotide sequence of a target polynucleotide comprising the steps of: (a) generating a plurality of amplicons from the target polynucleotide, each amplicon comprising multiple copies of a fragment of the target polynucleotide; (b) forming an array of amplicons on a nanopore array having labeled nanopores each with a FRET donor moiety; (c) identifying a sequence of at least a portion of each fragment in the amplicons by repeatedly forming sequencing reaction products thereon labeled with one or more optical labels and eluting the labeled sequencing reaction products through the labeled nanopores of the nanopore array, wherein each optical label is capable of accepting FRET energy from the FRET donor moiety and wherein the number and type of sequencing reaction product for each amplicon is determined by FRET signals generated by the optical labels; and (d) reconstructing the nucleotide sequence of the target polynucleotide from the identities of the sequences of the portions of fragments of the amplicons.

In some embodiments, the invention is directed to a method of determining a nucleotide sequence of a target polynucleotide comprising the steps of: (a) generating a plurality of amplicons from the target polynucleotide, each amplicon comprising multiple copies of a fragment of the target polynucleotide; (b) forming an array of amplicons on a nanopore array having labeled nanopores each with a FRET donor moiety; (c) identifying a sequence of at least a portion of each fragment in the amplicons by repeatedly forming sequencing reaction products thereon labeled with one or more optical labels and one or more resistive-pulse labels and eluting the labeled sequencing reaction products through the labeled nanopores of the nanopore array, wherein each optical label is capable of accepting FRET energy from the FRET donor moiety and wherein the number and type of sequencing reaction product for each amplicon is determined from correlated signals comprising a FRET signal generated by an optical label and a resistive-pulse signal; and (d) reconstructing the nucleotide sequence of the target polynucleotide from the identities of the sequences of the portions of fragments of the amplicons.

In futher embodiments, the invention is directed to a method of determining a nucleotide sequence of a target polynucleotide comprising the following steps: (a) forming at least one amplicon on a surface of or in layer on a nanopore array, the amplicon comprising at least one fragment of the target polynucleotide; and (b) identifying a sequence of at least a portion of each fragment in each amplicon by repeatedly forming sequencing reaction products thereon labeled with one or more resistive-pulse labels and eluting rise labeled sequencing reaction products through the nanopore array,

These above-characterized aspects, as well as other aspects, of the present invention are exemplified in a number of illustrated implementations and applications, some of which are shown in the figures and characterized in the claims section that follows. However, the above summary is not intended to describe each illustrated embodiment or every implementation of the present invention.

### BRIEF DESCRIPTION OF THE DRAWINGS

FIG. 1A illustrates the principle of detecting resistive-pulse labeled molecules.

FIG. 1B illustrates one embodiment of the apparatus of the invention employing bridge PCR amplified templates.

FIG. 1C illustrates one embodiment of the method of the invention for detecting nucleotides of a target polynucleotide by cycles of probe hybridization, ligation, and nanopore-based detection.

FIG. 1D illustrates the principle of detecting both resistive-pulse signals and FRET signals from the same labeled molecule or group of labeled molecules transiting a nanopore labeled with a FRET donor moiety, such as a quantum dot.

FIG. 2A illustrates an embodiment of the invention where nanoball amplicons and extension products are formed then disposed on a separation medium where the extension products are elated, separated and detected by nanopores.

FIG. 2B illustrates a form of the embodiment of FIG. 2A in which extension products are a nested set of fragment terminated by resistive-pulse labeled dideoxynucleotides and separated for nanopore detection.

FIGS. 3A-3B illustrate an embodiment where amplicons are formed in situ as polonies in a gel.

FIGS. 3C-3D illustrate a variant of the embodiment of FIGS. 3A-3B in which a separation layer is between a polony containing layer and a nanopore array

FIGS. 4A-4B illustrate first embodiments employing sequencing-by-synthesis reactions and resistive-pulse labeled and/or optically labeled pyrophosphates.

FIGS. 4C-4D illustrate second embodiments employing sequencing-by-synthesis reaction and resistive-pulse and/optically labeled pyrophosphates.

FIG. 5 diagrammatically illustrates the steps in a sequencing by synthesis process.

### DETAILED DESCRIPTION

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention. Guidance for making arrays of the invention is found in many available references and treatises on integrated circuit design and manufacturing and micromachining, including, but not limited to, Allen el al, CMOS Analog Circuit Design (Oxford University Press, 2^{nd} Edition, 2002); Levinson, Principles of Lithography, Second Edition (SPIE Press, 2005); Doering and Nishi, Editors, Handbook of Semiconductor Manufacturing Technology, Second Edition (CRC Press, 2007); Baker, CMOS Circuit Design, Layout, and Simulation (IEEE Press, Wiley-Interscience, 2008); Veendrick, Deep-Submicron CMOS ICs (Kluwer-Deventer, 1998); Cao, Nanostructures & Nanomaterials (Imperial College Press, 2004); and the like, which relevant parts are hereby incorporated by reference. Likewise, guidance for carrying out electrochemical measurements of the invention is found in many available references and treatises on the subject, including, but not limited to, Sawyer et al, Electrochemistry for Chemists, 2^{nd} edition (Wiley Interscience, 1995); Bard and Faulkner, Electrochemical Methods: Fundamentals and Applications, 2^{nd} edition (Wiley, 2000); and the like, which relevant parts are hereby incorporated by reference. Guidance for sample preparation and molecular biological aspects of the invention may be found in Ausubel et al, editor, Current Protocols in Molecular Biology (John Wiley & Sons, 1995); Sambrook et al. The Condensed Protocols from Molecular Cloning: A Laboratory Manual (Cold Spring Harbor Laboratories, 2006); and the like.

The invention is directed to methods, kits and compositions for using nanopores to detect and/or measure amounts of compounds, such as products or byproducts of nucleic acid sequencing reactions. Such detection or measurement may employ products or byproducts having resistive-pulse labels, optical labels, or labels that are capable of generating both optical and resistive pulse signals. Resistive-pulse labels are molecular labels bound or attached to an analyte which allows detection of the labeled analyte by a change in the electrical properties of a nanopore, such as trans-nanopore resistance. Labels for nanopore detection may also be optical labels, particularly acceptors of acceptor-donor pairs capable of undergoing fluorescent resonance energy transfer (FRET), where the donors are associated with the nanopore. In one aspect, multiple resistive-pulse labels may be employed to provide distinctive labels for multiple analytes in the same assay. A resistive-pulse label may be any molecule that is capable of affecting a current or a resistivity through a nanopore when such molecule traverses the nanopore. In one aspect, a method is provided for defecting a target polynucleotide or one or more nucleotides thereof by generating an extension product labeled with a resistive-pulse label and passing such labeled extension product through a responsive nanopore. In another aspect, a method is provided for determining the nucleotide sequence of a target polynucleotide by repeated cycles of forming resistive-pulse labeled extension products and eluting such products through a nanopore for identifying a resistive-pulse label associated with at least one nucleotide of the target polynucleotide. Extension products may be formed in a number of ways, such as by extending a primer by a nucleic acid polymerase at the presence of a resistive-pulse labeled nucleoside triphosphate (including, but not limited to, a resistive-pulse labeled dideoxynucleoside triphosphate) or by ligation of a resistive-pulse labeled oligonucleotide thereto or by any other technique that creates a resistive-pulse labeled product that encodes information about the target polynucleotide.

In some embodiments, resistive-pulse labels also serve as optical labels that enable detection by optical signals generated at or in a nanopore, e.g. as taught by Haber, International patent publication WO 2011/040996; Russell, U.S. Pat. No. 6,528,258: or the like, which are incorporated herein by reference. In particular, in some embodiments, the optical signal is a FRET signal, wherein an optical agent associated with a nanopore, e.g. a quantum dot, is excited by an illumination beam, after which an optical resistive-pulse label accepts the excitation energy from the agent (i.e. FRET donor) via a FRET mechanism and re-radiates an optical signal characteristic of the label. The invention includes detection of nucleotides from resistive-pulse labeled pyrophosphates that are also optical labels. In some embodiments, a nucleotide of a nucleic acid template is called based on a resistive pulse and an optical signal. That is, combined electrical and optical information from a label (or multiple identical labels) is used to determine a nucleotide or nucleotides of a template.

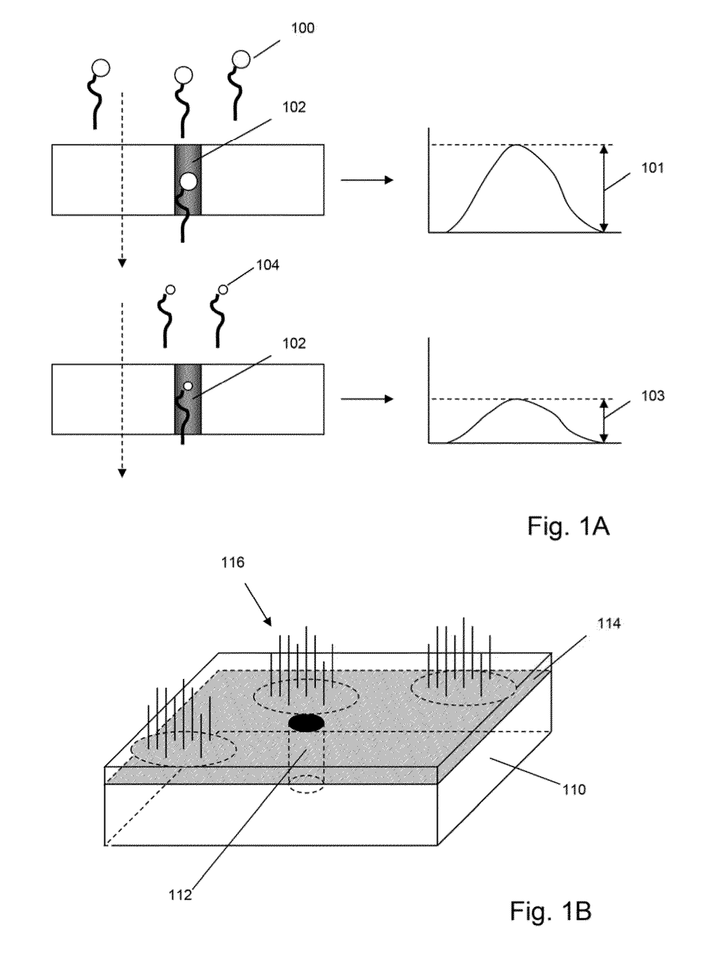

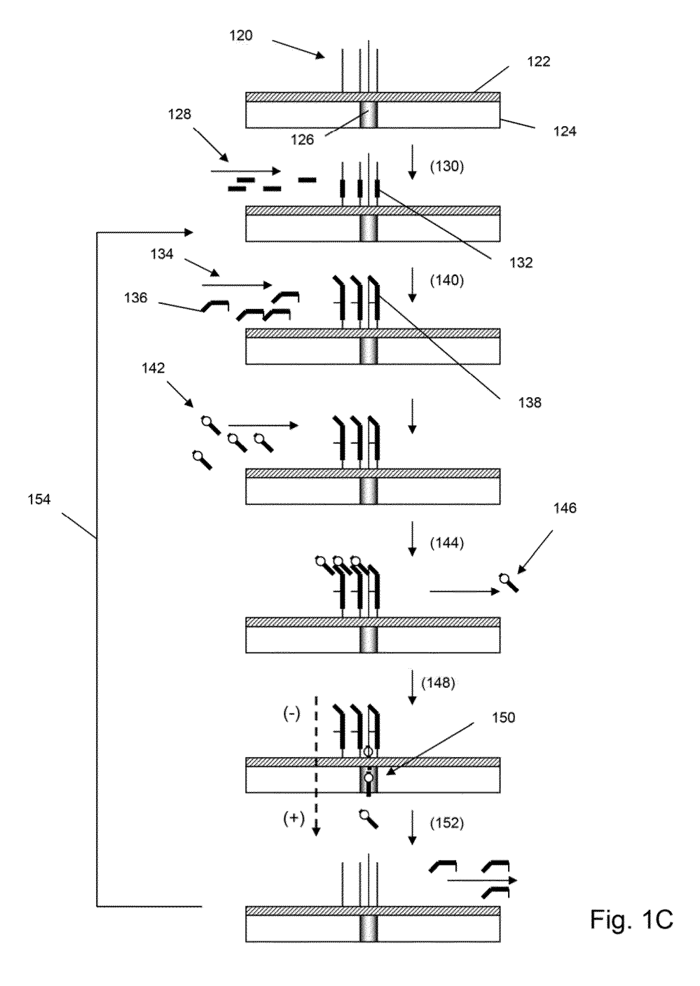

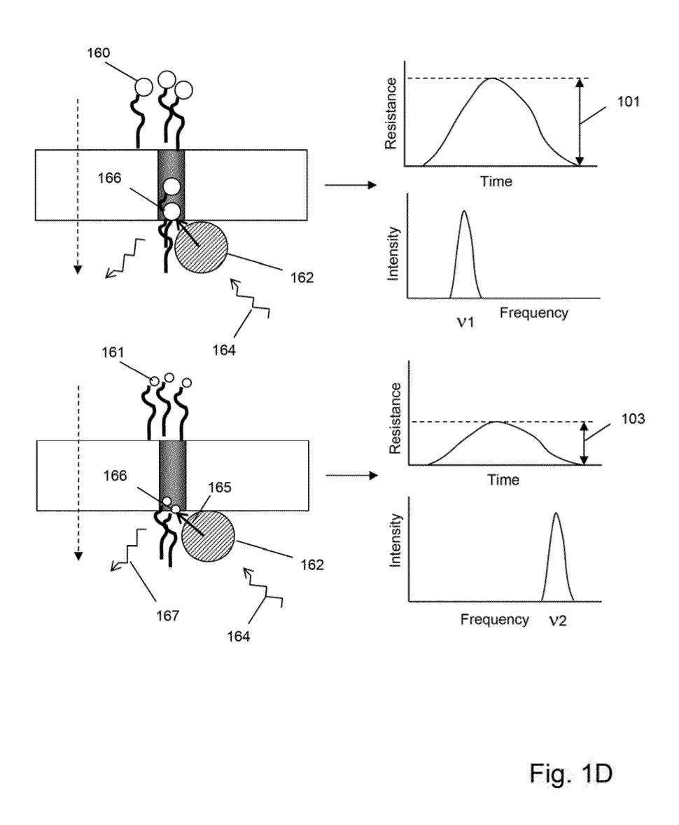

FIG. 1A illustrates the concept of a resistive-pulse label. In one aspect, distinctive resistive-pulse labels differ in molecular size (for example as measured by molecular weight), such that a larger sized label (100) generates a larger resistive pulse (101) across nanopore (102) than a resistive pulse (103) made by a smaller sized label (104). Exemplary resistive-pulse labels include currently used fluorescent and quencher labels, such as eosin, Texas Red, QSY-7 or the like, which are available in NHS esters from commercial sources and can be linked to nucleic acids and/or nucleotides via conventional linking groups, e.g. propargylamino, such as disclosed in Tiang et: al. International patent publication WO2002/30944, or the like.

In one aspect of the invention, amplicons of a target polynucleotide or fragments thereof are disposed in a layer or on a surface adjacent to one side of a substrate containing one or more nanopores. The amplicons may varying widely in form, and size and may comprise, but not be limited to, the following: amplified templates attached to beads or microparticles, a nanoball (i.e. product of tolling circle reaction), a product of a PCR, such as a budge PCR or a polony, a scaffolded nucleic acid polymer particle, or the like. Such amplicons are disclosed in the following exemplary references that are incorporated herein by reference; Kawashima et al., U.S. patent publication 2008/0286795; U.S. Pat. No. 7,115,400; Drmanae et al, U.S. Pat. No. 7,960,104; Hinz et al, U.S. patent publication 2010/0394982; Chetverin et al, U.S. Pat. No. 6,001,568; Chetverin et al, U.S. Pat. No. 5,616,478; Church et al, U.S. patent publication 2007/0087362; Mitra et al, Analytical Biochemistry, 320: 55-65 (2003); Mitra et al, Proc. Natl. Acad. Sci., 100: 5926-5931 (2003); Shendure et al, Science, 309(5741): 1728-1732 (2005); and the like. Exemplary amplicons are illustrated in FIG. 1B. There layer (114) (which may be a gel derivatized with primers) is disposed on substrate (110) containing nanopore (112) (or array of nanopores in other embodiments). Amplicons (116) are disposed randomly on and/or in layer (114) by carrying out a bridge PCR. Dedpending on the detection or sequencing chemistry employed, extension products are formed in the amplicons, after which (including optionally after a washing) the extension products are driven through nanopore (112), e.g. by pressure, electrophoresis, or the like. In one embodiment, extension products are driven though one or more nanopores by electrophoresis.

FIG. 1C illustrates a method of determining the nucleotide sequence of a target polynucleotide or template by cycles of extension product formation, labeling, washing, detection similar to the sequencing method disclosed in U.S. Pat. No. 7,960,104, which is incorporated herein by reference. Instead of detecting successfully made extension products optically, here the extension products are detected by one or more nanopores. Amplicon (120) is formed on layer (122) using bridge PCR or like technique. Layer (122) is disposed on substrate (124) containing one or more nanopores (126). A first probe (128) is hybridized (130) to sequences of amplicon (120) so that duplexes are formed where perfectly matched sequences occur (132). These are typically at a probe binding site engineered into the amplified fragments. Such operations and those that follow may take place in a flow cell in which different reagents are delivered to amplicons (120) at a predetermined rate and duration under computer control, e.g. as disclosed in Schultz et al, U.S. patent publication 2010/0300559, which is incorporated herein by reference. Mixed sequence probe (second probe) (134) is delivered (140) to amplicon (120). In one embodiment, there are four such probes, each with a different terminal base and corresponding label; that is, one has A as a terminal base, another has T, another G, and another C. The rest of the bases are degenerate. Whenever a perfect match is formed between such probe and the template, the first probe and second probe are ligated to form an extension product. Again, in one embodiment, second probes (134) have non-hybridizing portion (136) that may form a perfectly matched duplex with a corresponding resistive-pulse label oligonucleotide (142). After washing (144) to remove unreactied probes (146), conditions are altered (e.g. temperature increased, chaotropic agent introduced, or the like) so that bound labeled oligonucleotides may be eluted and driven (148), e.g. by electrophoresis, through nanopore (150) where they are detected. After detection, fast mi second probes are removed (152) front templates in amplicon (120) and the cycle is repeated (154). Clearly, other ligation-based sequencing chemistries may be employed, such as disclosed in Macevicz, U.S. Pat. No. 5,750,341: Drmanac et al, Science, 327(5961): 78-81 (2010) and Shendure et al, Science, 309(5741): 1728-1732(2005); which are each incorporated herein by reference. The above embodiment may be implemented by the following steps: (a) arraying the one or more amplicons of the target polynucleotide on a surface of a nanopore array; (b) hybridizing one or more probes from a first set of probes to the amplicons under conditions that permit the formation of perfectly matched duplexes between the one or more probes and complementary sequences on the amplicons; (c) hybridizing one or more probes from a second set of probes to the amplicons under conditions that permit the formation of perfectly matched duplexes between the one or more probes and complementary sequences on the amplicons, at least one of the probes front the first set or the second set have a resistive-pulse label; (d) lighting probes from the first and second sets hybridized to an amplicon at contiguous sites: (e) eluting the ligated first and second probes through at least one nanopore of the nanopore array to identify one or more nucleotides thereof by its resistive-pulse label; and (f) repeating steps (b) through (e) until the sequence of the target polynucleotide can be determined from the identities of nucleotides of the ligated probes.

FIG. 1D illustrates an embodiment of the invention where both a resistive-pulse signal and a FRET signal are used to identify a sequencing reaction product and/or measure the quantity of such product. As with. FIG. 1A, labels of different sequencing reaction products are indicated by different sized circles (160) and (161). In some embodiments, labels generated by successive extensions (e.g. in a sequencing by synthesis embodiment), need not be different. The identity of successive bases in a template is determined by the identities of the successive precursors provided to a polymerase-primer-template complex. In some embodiments, labels (160) and (161) may be different resistive-pulse labels and different optical labels, wherein a base call is based on the correlated signals generated by changes to nanopore resistance and FRET signal during transit of the nanopore. As in FIG. 1A, larger-sized label (160) generates a larger resistive-pulse signal (101) (i.e. increase in nanopore resistance, or other property, such as decrease in current, change in capacitance., etc.) and smaller-sized label (161) generates a smaller resistive-pulse signal. In some embodiments, selection of different sized labels for generating resistive-pulse signals of different magnitudes is accomplished by selecting molecules of different molecular weights. For example, polymers labels used in certain electrophoretic detection schemes may be used as resistive-pulse labels, e.g. Grossman, U.S. Pat. No. 6,395,486; Grossman el al, U.S. Pat. No. 5,807,682; and the like, which patents are incorporated herein by reference. As discussed further below, a FRET donor moiety (162), such as a quantum dot, may be associated with the same nanopore. Upon excitation (164) of FRET donor moiety (162), energy is nonradiatively transferred (165) to acceptor label (166), after which the energy is radiated at a lower frequency FRET signal (167).

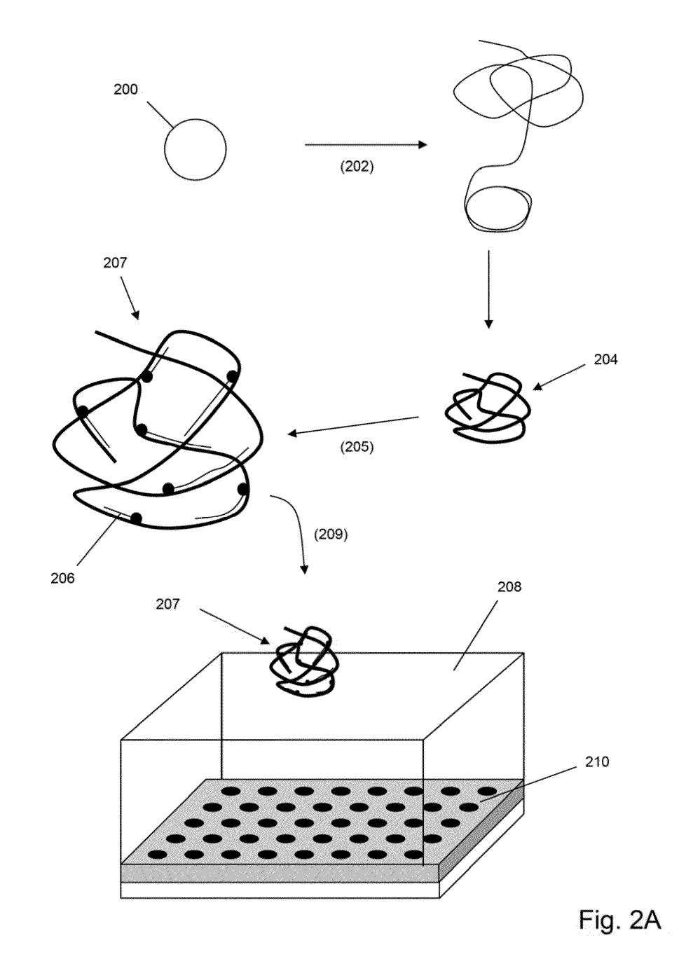

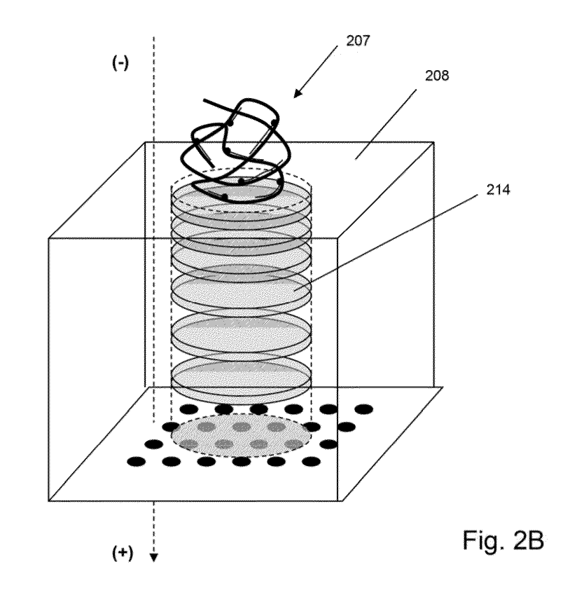

FIGS. 2A-2B illustrate another embodiment of the invention in which amplicons are generated by rolling circle amplification, which is taught in numerous references, including but not limited to, U.S. Pat. No. 7,960,104; U.S. Pat. No. 5,854.033; U.S. Pat. No. 5,354,668; U.S. Pat. No. 6,284,497; which patents are incorporated herein by reference. In this embodiment, templates or fragments to be sequenced are converted into single stranded circles (200) including a primer binding site. A primer is anneal to such site and extended (202) by a nucleic acid polymerase to form rolling circle amplicon (204), which is then isolated and combined with sequencing primers anneal that anneal to the primer binding site for amplification (or its complement). A Sanger sequencing reaction is then carried out (205) producing on amplicon (204) a nested set of extension products (206) each terminated with a resistive-pulse labeled dideoxynucleotide, so that a distinctive label is associated with each of the four nucleotides, A, C, G and T. Alter gentle washing, amplicons (207) with their extension products attached are disposed (209) on gel layer (208) which, in turn, is disposed on nanopore array (210). Amplicons (206) are disposed at a density so that only a single layer of amplicons (206) are present and have an average nearest neighbor distance large enough so that eluted extension products do not mix. As illustrated in FIG. 2B, extension products (206) are eluted from amplicons (207), e.g. by electrophoresis, and driven through gel layer (208) where they form bands (214), whose labeled extension products are detected in sequence by nanopore array (210). The above embodiment may be implemented by the following steps; (a) generating extension products from primers annealed to the one or more amplicons, the extension products each having a size and a resistive pulse terminator at one end and forming a nested set of sequences within each amplicon, the resistive, pulse terminator producing upon passage through a nanopore a distinctive resistive pulse characteristic of the terminal nucleotide; (b) arraying the one or more amplicons on a surface of a layer of separation medium disposed on a nanopore array; (c) separating the extension products through the separation medium and nanopore array so that a resistive pulse terminator is identified for each extension product; and (d) determining the nucleotide sequence of the at least one nucleic acid template from a sequence of resistive pulses generated by the resistive pulse terminators of the extension products.

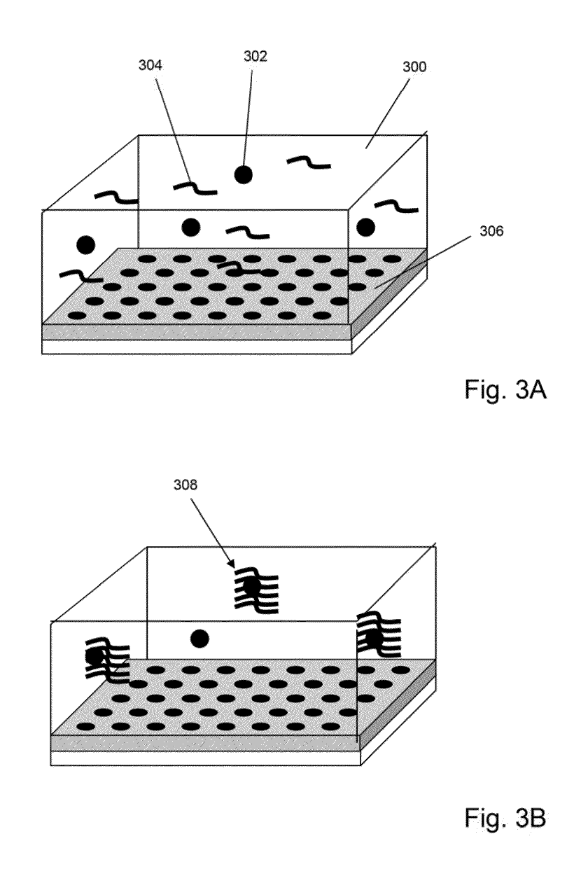

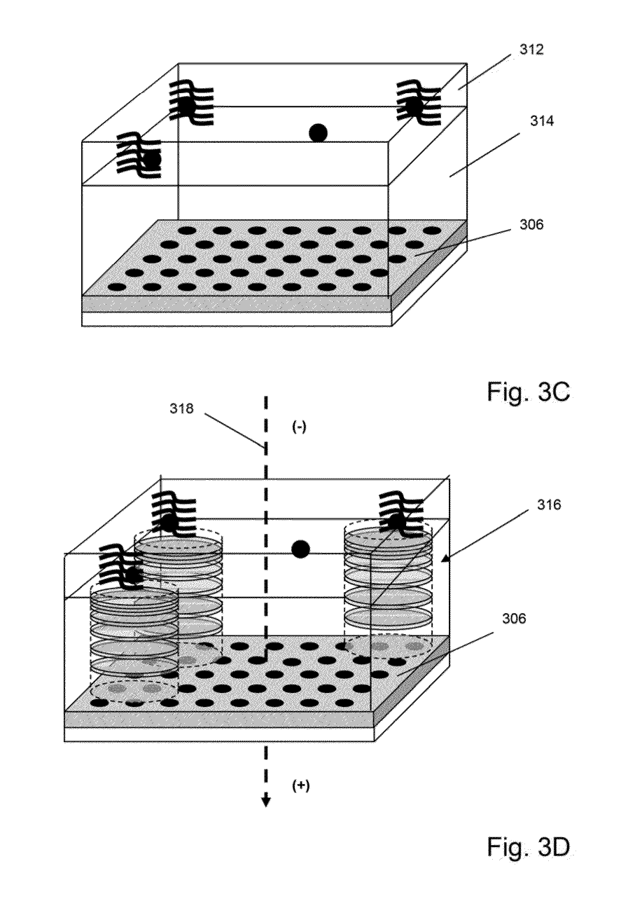

FIGS. 3A-3B illustrate another embodiment of the invention in which amplicons are formed as polonies in a gel layer. The formation of polonies is disclosed in the following references which are incorporated by reference; U.S. Pat. No. 6,001,568; U.S. Pat. No. 5,616,478: U.S. patent publication 2007/0087362; Mitra et al. Proc. Natl. Acad. Sci., 100; 5926-5931 (2003); Mitra et al, Anal. Biochem. 320: 55-65 (2003); and the like. Gel (300) derivatized with primers and containing components of a PCR (such as polymerase (302) and templates (304)) is disposed on nanopore array (306). After a PCR is carried out in gel (300) localized amplicons (308) are formed. In one embodiment, two gel layers may be disposed on nanopore array (306): gel layer (310) containing polony amplicons and gel layer (312) that provides a separation medium for separating extension products (as shown in FIG. 3D) in some embodiments, such as that shown in which a Sanger reaction is carried out to produce a nested set of extension products that are separated, e.g. electrophoretically via electrical field (318), forming bands (316) that are detected by nanopore array (306).

In some embodiments, the above method may be implemented by the following steps; (a) forming an array of amplicons on a surface of or in layer on a nanopore array, the amplicons each comprising a fragment of the target polynucleotide; and (b) identifying a sequence of at least a portion of each fragment in each amplicon by repeatedly forming sequencing reaction products thereon labeled with one or more resistive-pulse labels and eluting the labeled sequencing reaction products through the nanopore array, where labeled sequencing reaction products are identified and/or quantified by the nanopores of the nanopore array by their respective resistive-pulse labels. Likewise, in some other embodiments, methods described further below may be implemented by the following steps: (a) forming an array of amplicons on a surface of or in layer on a nanopore array having labeled nanopores, the amplicons each comprising a fragment of the target polynucleotide; and (b) identifying a sequence of at least a portion of each fragment in each amplicon by repeatedly forming sequencing reaction products thereon labeled with one or more optical labels and during the labeled sequencing reaction products through the nanopore array, where labeled sequencing reaction products are identified and/or quantified by FRET signals generated by the labeled nanopores of the nanopore array. In different embodiments, sequencing reaction products may be extension products (that is, for example, primers extended along a template strand by a nucleic acid polymerase), labeled pyrophosphates released in an extension reaction, labels on bases of incorporated nucleoside triphosphates released in a separate label releasing step, labeled 3′ blocking groups released in a separate de-blocking step, and the like.

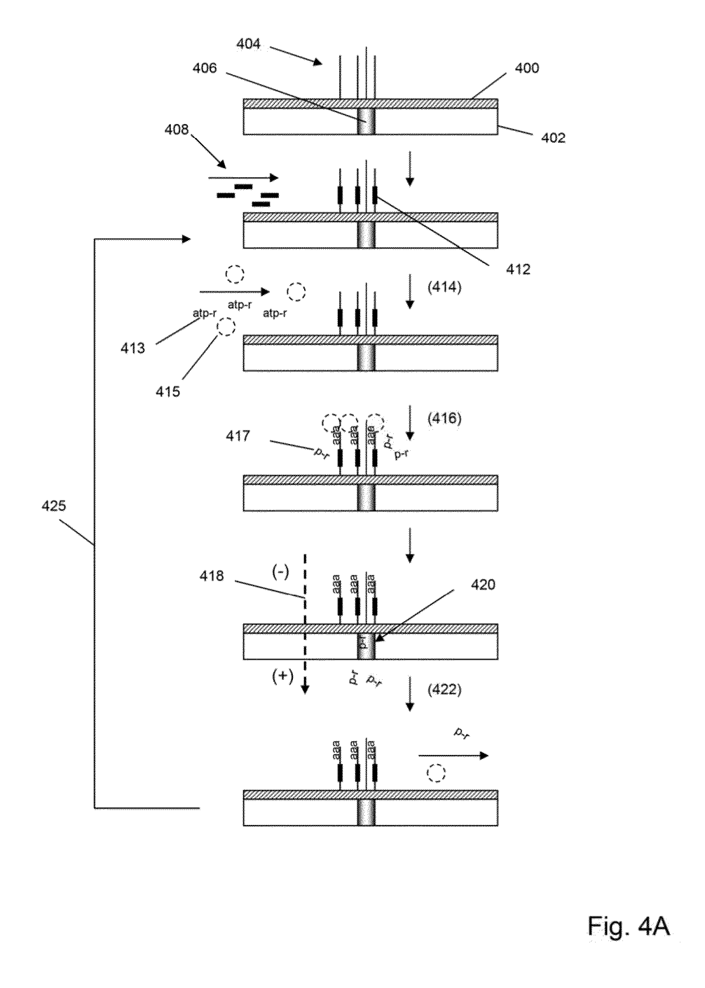

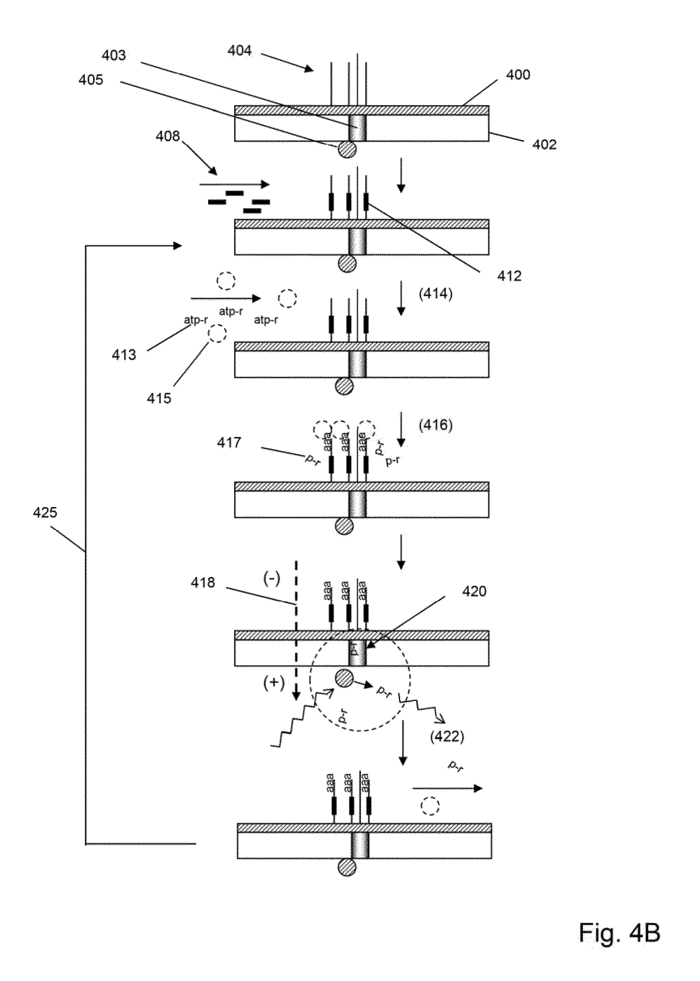

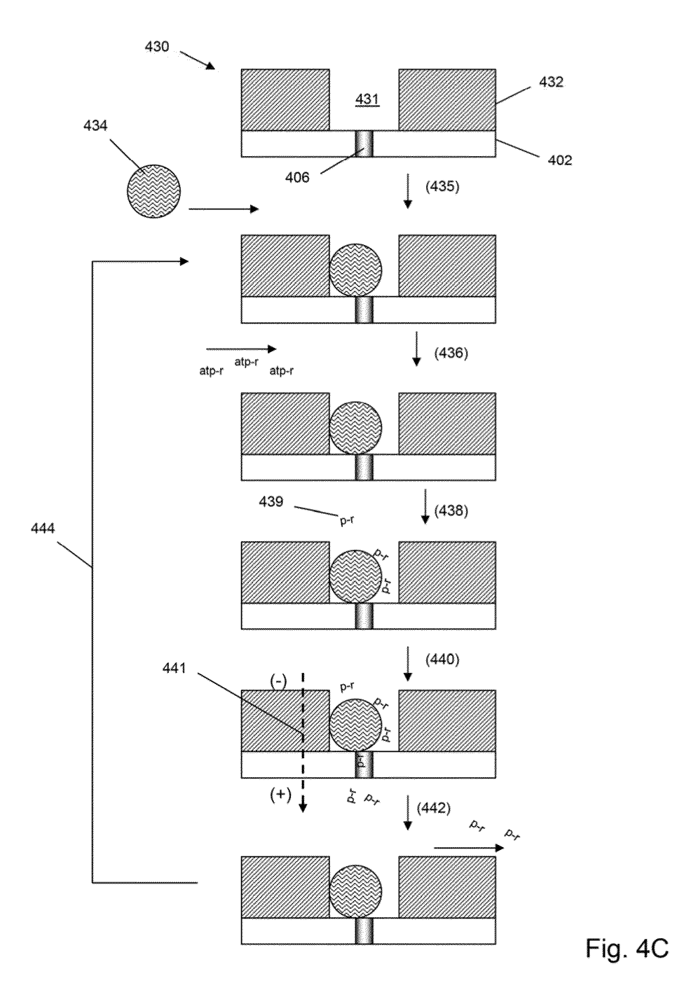

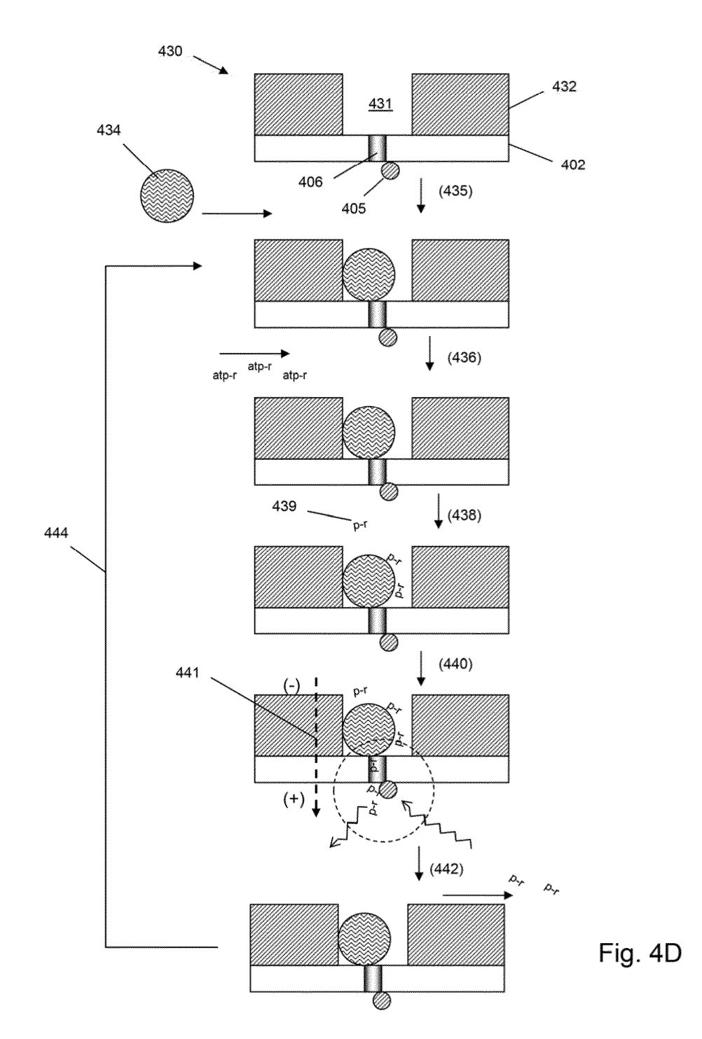

In one aspect, methods of the invention may include the generation of resistive pulse signals via sequencing-by-synthesis chemistries employing resistive-pulse labeled pyrophosphates. Such chemistries are disclosed in the following exemplary references which are incorporated herein by reference: Fuller et al. Nature Biotechnology, 27: 1013-1023 (2009); Ronaghi, Genome Research, 11: 3-11 (2001); Ronaghi et al, Science, 281: 363-365 (1998); Ronaghi, U.S. Pat. No. 6,828,100; Margulies et al. Nature, 437; 376-380 (2005); and the like. Exemplary nucleoside triphosphates that generate labeled pyrophosphates upon incorporation in a polymerase extension reaction are disclosed in the following references which are incorporated herein by reference: Sims et al, Nature Methods, 8: 575-580 (2011); Korlach et al, Nucleosides, Nucleotides and Nucleic Acids, 27: 1072-1083 (2008); Korlach et al, U.S. Pat. No. 7,361,466; Williams, U.S. Pat. No. 6,255,083; Williams et al, U.S. Pat. No. 6,869,764; Williams, U.S. Pat. No. 7,229,799; and the like. An exemplary embodiment of this aspect of the invention is illustrated in FIG. 4A. As above, solid support (402) contains nanopore (406) and circuitry for measuring nanopore current and has layer (400), e.g. a thin gel or membrane, on which (or in which) amplicon (404) is formed. This structure may be place in a flow cell for introducing reagents to amplicons (404). In accordance with one embodiment, primers (408) are introduced and annealed (410) to templates of amplicon (404) to form duplexes (412), after which resistive-pulse labeled nucleoside triphosphates (413) and a DNA polymerase (415) are introduced (414) to primer-template duplexes (412). Polymerase (415) extends primers annealed to templates (416) whenever adjacent template nucleotides are complements of the introduced nucleoside triphosphates thereby releasing resistive-pulse labeled pyrophosphates (417). During extension reaction (416) flow at amplicon (404) may be halted and electric field (418) is established so that at least a portion of released pyrophosphates are induced to traverse (420) nanopore (406). The number of released resistive-pulse labeled pyrophophates traversing nanopore (406) is proportional to the number of bases incorporated in extension reaction (416). After completion of extension reaction (416) and measurement of resistive pulse labeled pyrophosphates traversing nanopore (406), flow is resumed and unreacted nucleoside triphosphates, polymerase, and released pyrophosphate is removed. Further such cycles (425) of delivering resistive-pulse labeled nucleoside triphosphates to templates, extending a sequencing printer to generate resistive-pulse labeled pyrophosphate in an amount proportional to the number of bases added in such extension reaction, and measuring resistive-pulse labeled pyrophosphates is carried out to sequence templates of amplicon (404). A sequencing operation may comprise sets of four such cycles each being carried out with a different one of the four natural nucleotides, rATP, rTTP, rCTP and rGTP, where “r” indicates a resistive-pulse labeled phosphate. Another exemplary embodiment of this aspect of the invention is illustrated in FIG. 4C. Microwell array (430) is disposed on solid support (402) containing nanopores and circuitry for measuring nanopore current. Microwells (431) may include one or more nanopores (406). Amplicons of template nucleic acids may be prepared separately, e.g. on beads or other particles as illustrated by (434), using conventional techniques, such as emulsion PCR, e.g. Margulies et al (cited above), after which such solid phase amplicons are deposited (435) in microwells (431). Prior to such deposition, optional enrichment steps may be carried out and primers and polymerase may be added to form primer-template-polymerase complexes that are ready to extend whenever exposed to nucleoside triphosphates. As with the embodiment of FIG. 4A, resistive pulse labeled nucleoside diphosphates are delivered (436) to solid phase amplicon (434) where upon extension reaction (438) occurs generating resistive-pulse labeled pyrophosphate (439). Electric field (441) drives a portion of the released pyrophosphate through nanopore (406) where they are measured. After optional wash step (442), the cycle of delivering, extending, and measuring is repealed (444). In both of the above embodiments, electrical field (418) and (441) may either be on continuously or it may be turned on and off in synchrony with extension reactions (416) and (438). As described above in FIG. 1D, both the embodiments of FIGS. 4A and AC may include a nanopore (403) labeled with FRET generating moiety (405) and use of sequencing reaction product (acceptor) labels capable of generating FRET signals.

Some of the above embodiments may be implemented by the following steps: (a) generating a plurality of amplicons from the target polynucleotide, each amplicon comprising multiple copies of a fragment of the target polynucleotide and the plurality amplicons including a number of fragments that substantially covers the target polynucleotide; (b) forming an array of amplicons on a surface of or in layer on a nanopore array: (c) identifying a sequence of at least a portion of each fragment in the amplicons by repeatedly forming extension products thereon labeled with on or more resistive-pulse labels and eluting the labeled extension products through the nanopore array; and (d) reconstructing the nucleotide sequence of the target polynucleotide from the identities of the sequences of the portions of fragments of the amplicons. Some of the above embodiments may also be implemented by the following steps: (a) generating a plurality of amplicons from the target polynucleotide, each amplicon comprising multiple copies of a fragment of the target polynucleotide; (h) forming an array of amplicons on a nanopore array having labeled nanopores each with a FRET donor moiety; (c) identifying a sequence of at least a portion of each fragment in the amplicons by repeatedly forming sequencing reaction products thereon labeled with one or more optical labels and eluting the labeled sequencing reaction products through the labeled nanopores of the nanopore array, wherein each optical label is capable of accepting fluorescence resonance energy transfer (“FRET energy”) from the FRET donor moiety and wherein the number and type of sequencing reaction product for each amplicon is determined by FEET signals generated by the optical labels; and (d) reconstructing the nucleotide sequence of the target polynucleotide from the identities of the sequences of the portions of fragments of the amplicons. In some embodiments, the step of eluting sequencing reaction products is accomplished by establishing an electrical field across the nanopore array so that charged sequencing reaction products are driven through nanopores of the nanopore array.

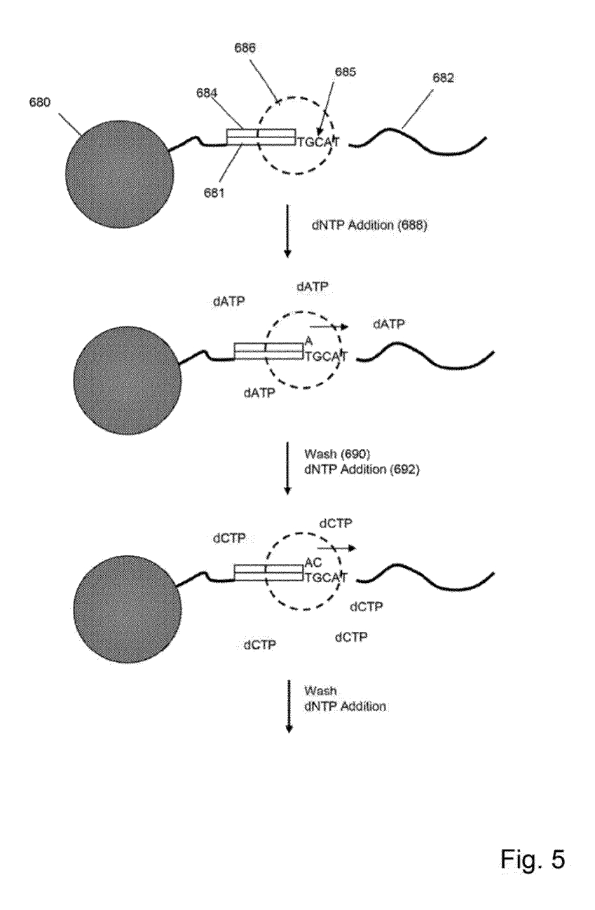

Sequencing by synthesis is well known to those-of ordinary skill in the art as exemplified by the following references which are incorporated by reference. Nobile et al, U.S. patent publication 2010/0300895; Bentley et al, Nature, 456: 53-59 (2008): Balasubramanian, U.S. Pat. No. 6,833.246; Leamon et al, U.S. Pat. No. 7,323,305. In one embodiment, templates each having a primer and polymerase operably bound are loaded into reaction chambers (such as microwells), after which repeated cycles of deoxynucleoside triphosphate (dNTP) addition and washing are carried out. In some embodiments, such templates may be attached as clonal populations to a solid support, such as microparticle, bead, or the like, and such clonal populations are loaded into reaction chambers. For example, templates may be prepared as disclosed in. U.S. Pat. No. 7,323,305, which is incorporated by reference. As used herein, “operably bound” means that a primer is annealed to a template so that the primer's 3′ end may be extended by a polymerase and that a polymerase is bound to such primer-template duplex, or in close proximity thereof so that binding and/or extension takes place whenever phosphate-labeled dNTPs are added. In each addition step of the cycle, the polymerase extends the printer by incorporating added dNTP only if the next base in the template is the complement of the added dNTP. If there is one complementary base, there is one incorporation, if two, there are two incorporations, if three, there are three incorporations, and so on. With each such incorporation there is a labeled pyrophosphate released. The production of labeled pyrophosphates is monotonically related to the number of contiguous complementary bases in the template (as well as the total number of template molecules wife primer and polymerase that participate in an extension reaction). Thus, when there is a number of contiguous identical complementary bases in the template (i.e. a homopolymer region), the number of labeled pyrophosphates released is proportional to the number of contiguous identical complementary bases. (The corresponding output signals are sometimes referred to as “1-mer”, “2-mer”, “3-mer” output signals, and so on), if the next base in the template is not complementary to the added dNTP, then no incorporation occurs and no labeled pyrophosphate is released (in which case, the output signal is sometimes referred to as a “0-mer” output signal.) In each wash step of the cycle, a wash solution is used to remove the dNTP of the previous step in order to prevent misincorporations in later cycles. Usually, the four different kinds of dNTP are added sequentially to the reaction chambers, so that each reaction is exposed to the four different dNTPs one at a time, such as in the following sequence: dATP, dCTP, dGTP, dTTP, dATP, dCTP, dGTP, dTTP, and so on, with each exposure followed by a wash step. The process is illustrated in FIG. 5 for template (682) with primer binding site (681) attached to solid phase support (680). Primer (684) and DNA polymerase (686) operably bound to template (682). Upon the addition (688) of dNTP (shown as dATP), polymerase (686) incorporates a nucleotide since “T” is the nest nucleotide in template (682). Wash step (690) follows, after which the next dNTP (dCTP) is added (692). Optionally, after each step of adding a dNTP, an additional step may be performed wherein the reaction chambers are treated with a dNTP-destroying agent, such as apyrase, to eliminate any residual dNTPs remaining in the chamber, which may result in spurious extensions in subsequent cycles.

In one embodiment, a sequencing method exemplified in FIG. 5 may be carry out using the apparatus of the invention in the following steps: (a) disposing a plurality of template nucleic acids into a plurality of reaction chambers disposed on a sensor array, the sensor array comprising a plurality of sensors and each reaction chamber being disposed on and in a sensing relationship with at least one sensor configured to provide at least one output signal representing a sequencing reaction byproduct proximate thereto, and wherein each of the template nucleic acids is hybridized to a sequencing primer and is bound to a polymerase; (b) introducing a known nucleotide triphosphate into the reaction chambers; (c) detecting incorporation at a 3′ end of the sequencing primer of one or more nucleotide triphosphates by a sequencing reaction byproduct if such one or more nucleotide triphosphate are complementary to corresponding nucleotides in the template nucleic acid, wherein the sequencing reaction byproduct is labeled with an resistive-pulse label and/or an optical label capable of generating a FRET signal and wherein the sequencing reaction byproduct is measured by its resistive-pulse label or its optical label or both; (d) washing unincorporated nucleotide triphosphates from the reaction, chambers; and (c) repeating steps (b) through (d) until the plurality of template nucleic acids are sequenced.

In some embodiments, the invention provides for nanopore-based detection of released labels in a sequencing-by-synthesis process. The released labels may be resistive-pulse labels or optical labels or both. In one embodiment, release labels are detected by their electrical signal and their optical signal. Typically releasable labels are attached to nucleotide precursors and are cleaved from an incorporated nucleotide cither during the incorporation reaction or in a separate cleavage step. In some embodiments, releasable labels are attached to a phosphate of the nucleoside triphosphate precursors and are released as labeled pyrophosphates as a result of incorporation, e.g. as described in Korlach et ah U.S. Pat. No. 7,361,466; or Williams et al, U.S. Pat. No. 6,869,764. The labeled pyrophosphate may be a resistive-pulse label and/or an optical label. In some embodiments, releasable labels are labeled 3′ blocking groups attached to a 3′ hydroxyl of the nucleoside triphosphate precursors and are released in a separate cleavage or de-blocking step after incorporation, e.g. Barnes et al, U.S. Pat. No. 7,057,026; Kwiatkowski, U.S. Pat. No. 6,309,836 (3′-hydrocarbyldithiomethyl-modified nucleotides); Ju et al, International patent publication WO 2012/083249: Ju et al, U.S. Pat. No. 7,622,279; Ju et al, U.S. Pat. No. 6,627,748, Ju et al, U.S. Pat. No. 7,883,369; which are incorporated herein by reference. Examples of useful labels attached to 3′-hydrocarbyldithiomethlyl blocking groups include bodipy, dansyl, fluorescein, rhodamin, Texas red, Cy 2, Cy 4, and Cy 6. Such labeled 3′ blocking groups are release in a cleavage step of treating with a mild reducing agent under neutral conditions.

Suitable labels for generating FRET signals include the following: Fluorescent dyes: Xanthine dyes, Bodipy dyes, Cyanine dyes Chemiluminiscent compounds: 1, 2-dioxetane compounds (Tropix inc., Bedford, Mass.). Amino acids & Peptides: naturally occurring or modified aminoacids and polymers thereof. Carbohydrates: glucose, fructose, galactose, mamose, etc. NMPs & NDPs; nucleoside-monophosphates, nucleoside-diphosphates. Aliphatic or aromatic acids, alcohols, thiols, substituted with halogens, cyano, nitro, alkyl, alkenyl, alkynyl, azido or other such groups. A variety of nucleotide reversible terminators (NRTs) for DNA sequencing by synthesis (SBS) are synthesized wherein a cleavable linker attaches a fluorescent dye to the nucleotide base and the 3′ —OH of the nucleotide is blocked with a small reversible terminating group. Using these NRTs, DNA synthesis is reversibly stopped at each position. After recording the fluorescent signal from the incorporated base, the cleavable moieties of the incorporated nucleotides are removed and the cycle is repeated. The same type of nucleotides can also be used for nanopore DNA sequencing. A small blocking group at 3′ —OH and a resistive-pulse and/or optical label attached at the base linked through a cleavable linker can be synthesized. After polymerase extension reaction, both the 3′ —O-blocking group and the tag from the base are cleaved and the released tag can be used to pass through the nanopore and the blockage signal monitored. Four different tags (e.g. different length and molecular weight poly-ethylenene glycols (PEGs), can be used, one for each of the four bases, thus differentiating the blockage signals. A bulky dNMP may be introduced through a cleavable linker. Thus, different dNMPs are introduced through a linker according to the original dNTP. For example, with dTTP nucleotide, a dTMP is introduced (for dATP, a dAMP, for dGTP, a dGMP and for dCTP, a dCMP is introduced). After polymerase incorporation and cleavage with TCEP, modified dNMPs are generated which are passed through the nanopore channel and detected by appropriate methods. 3′ —O—2-nitrobenzyl and 3′ —O-azidomethyl attached dNTPs are good substrates for DNA polymerases. After incorporation by DNA/RNA polymerase in a sequencing reaction, these 3′-0-tagged nucleotides terminate the synthesis after single base extension because of the blocking group at the 3′-OH. Further extension is possible only after cleavage of the blocking group from the 3′-0 position. The 3′-O-2-nitrobenzyl group can be efficiently cleaved by UV light and 2′-O-azidomethyl by treatment with TCEP to generate the free OH group for further extension. The cleaved product from the reaction is monitored for electronic blockage by passing through the nanopore and recording the signal. Four different substituted nitrobenzyl protected dNTPs and four different azidomethyl substituted dNTPs, one for each of the four bases of DNA, are synthesized.

Nanopores, Nanopore Arrays, Fabrication And Detecting Resistive-Pulse Signals

Resistive-pulse labeled analytes are identified by nanopores and/or nanopore arrays. Such nanopores and nanopore arrays may be constructed using nanofabrication techniques, protein, engineering, or combinations of both technologies. The following exemplary references that are incorporated by reference disclose construction and operation of nanopores and nanopore arrays: Feier, U.S. Pat. No. 4,161,690; Ling, U.S. Pat. No. 7,678,562; Hu et al, U.S. Pat. No. 7,397,232; Golovchenko et al, U.S. Pat. No. 6,464,842; Chu et al, U.S. Pat. No. 5,798,042; Sauer et al, U.S. Pat. No. 7,001,792; Su et al, U.S. Pat. No. 7,744,816; Church et al, U.S. Pat. No. 5,795,782; Bayley et al, U.S. Pat. No. 6,426,231; Akeson et al, U.S. Pat. No. 7,189,503; Bayley et al, U.S. Pat. No. 6,916,665: Akeson et al, U.S. Pat. No. 6,267,872: Meller et al. U.S. patent publication 2009/0029477; Howorka et al, International patent publication WO2009/007743; Brown et al, International patent publication WO2011/067559; Meller et al. International patent publication WO2009/020682; Polonsky et al, International patent publication WO2008/092760; Van der Zaag et al, International patent publication WO2010/007537; Yan et al, Nano Letters, 5(6): 1129-1134 (2005); Iqbal et al. Nature Nanotechnology, 2: 243-248 (2007); Wanunu et al, Nano Letters, 7(6): 1580-1585 (2007); Dekker, Nature Nanotechnology, 2: 209-215 (2007); Storm et al. Nature Materials, 2: 537-540 (2003); Wu et al. Electrophoresis, 29(13): 2754-2759 (2008); Nakane et al. Electrophoresis, 23: 2592-2601 (2002); Zhe et al, J. Micromech. Microeng., 17: 304-313 (2007); Henrique et al. The Analyst, 129: 478-482 (2004): Jagtiani et al, J. Micromech. Microeng., 16: 1530-1539 (2006): Nakane et al, J. Phys. Condens. Matter, 15 R1365-R1393 (2003); DeBlois et al, Rev. Sci. Instruments, 41(7): 909-916 (1970); Clarke et al, Nature Nanotechnology, 4(4): 265-270(2009); Bayley et al, U.S. patent publication 2003/0215881; and the like. Briefly, in one aspect, a channel is formed through a substrate (e.g. 110 of FIG. 1B) through which a current may be induced to flow. Such substrate may comprise various materials, including but not limited to, silicon, lipid bilayers, protein nanopores, semiconductor materials, or the like. The channel is dimensioned so that analytes may pass through from one side of the substrate to the other side. During such transit the flow of current is disrupted, wherein the degree and/or nature of such disruption depends at least in part on a resistive-pulse label. Associated with the substrate is a current detection circuit, e.g. disclosed in Feier (cited above) or the like, that detects a disruption in current flow, i.e. a resistive pulse, and generates a signal related thereto which is collected and analyzed to identify a resistive-pulse label. In one aspect, nanopore and/or nanopore array detectors may be implemented in a microfluidics device, e.g. as disclosed in Shultz et al (cited above).

“Detection region” with respect to nanopores refers to a region in which products of a sequencing reaction are detected. The detection region can be within the pore, juxtaposed on the pore, on the pore entrance or exit, or present through a portion or the entirely of the pore. Various configurations will depend on the detection mode used: to detect the products of the sequencing reaction. Upon translocation through the pore, optical and/or resistive-pulse labeled products are interrogated at the detection region to detect a detectable property associated with them. Suitable detection modes include, by way of example and not limitation, current blockade, electron tunneling current, charge-induced field effect, and/or pore transit time, fluorescent resonance energy transfer (FRET) as further described below. Detection of the detectable property of the labeled products generates an electrical and/or optical signal pattern that identifies the product and its magnitude, which in the case of some sequencing by synthesis techniques depends on whether a stretch of one, two, three, or more, nucleotide precursors are incorporated into a template. This signal pattern associated with the detected, product can be compared to a set of reference signal patterns to assist in correlating the measured signal pattern to a specific product in the mixture. Reference signal patterns can be obtained by analyzing known model sequences separately to ascertain the characteristic or signature signal patterns associated with each product in the reaction. A variety of detection modes are applicable to the methods herein

In some embodiments, the detectable property is the effect of the translocated products on the electrical properties of the nanopore. Pore electrical properties include among others, current amplitude, impedance, duration, and frequency. Devices for detecting the pore's electrical properties typically comprise a pore incorporated into a thin film or a membrane, where the film or membrane separates a cis chamber and a trans chamber connected by a conduction bridge. The mixture to be analyzed is placed on the CIS side of the pore in an aqueous solution, typically comprising one or more dissolved salts such as potassium chloride. Application of an electric field across the pore using electrodes positioned in the cis and trans side can be used to direct translocation of the products through the pore. The size and geometry of the product can affect the migration of ions through the pore, thereby altering the pore's electrical properties. Current is measured at a suitable time frequency to obtain sufficient data points to detect a current signal pattern. The generated signal pattern can then be compared to a set of reference patterns to identify the product being detected. Shifts in current amplitude, current duration, and current magnitude define a signal pattern for the specific product in the mixture. Measurement of current properties of a pore, such as by patch clamp techniques, is described in various reference works, for example, Hille, B, 2001, Ion Channels of Excitable Membranes, 3rd Ed., Sinauer Associates, Inc., Sunderland, M A. In some embodiments, the detected property is quantum tunneling of electrons. Quantum tunneling is the quantum-mechanical, effect of transitioning through a classically-forbidden energy state via a particle's quantum wave properties. Electron tunneling generally occurs where a potential barrier exists for movement of electrons between a donor and an acceptor.

In some embodiments, the detection technique can be based on imaging charge-induced fields, as described in U.S. Pat. No. 6,413,792 and U.S. published application No. 2003/0211502, the disclosures of which are incorporated herein by reference. Semiconductor devices for detection based on charge induced fields are also described in these references. Application of a voltage between a source region and a drain region results in flow of current from the source to the drain if a channel for current flow forms in the semiconductor. Because each sequencing reaction product can have an associated charge, passage of a product through the semiconductor pore can induce a change in the conductivity of the semiconductor material lining the pore, thereby inducing a current of a specified magnitude and waveform. Currents of differing magnitude and waveform can be produced by different products because of differences in charge, charge distribution, and size of the molecules. In the embodiments disclosed in U.S. Pat. No. 6,413,792, a product passes through a pore formed of a p-type silicon layer. Translocation of the products can be achieved by methods similar to those used to move a product through other types of channels, as described herein. The magnitude of the charge-induced current is expected to be on the order of microampere range, which is higher than the picoampere currents expected for electron tunneling-based detection. It is to be understood that although descriptions above relate to individual detection techniques, in some embodiments, a plurality of different techniques can be used to examine the binding mixture. Examples of multiple detection modes include, among others, current blockade in combination with electron tunneling current, and current blockage in combination with imaging charge induced fields.

Concurrent detection with different detection modes can be used to identify a product by correlating the detection time of the resulting signal obtained from different detection modes, such as optical and resistive-pulse. As described above, various devices employing the various detection modes can be used for analyzing products of a sequencing reaction. These include, among others, biological based systems that employ a biological pore or channel embedded in a membrane and solid state systems in which the channel or pore is made whole or in part from a fabricated or sculpted solid state component, such as silicon. Devices using biological pores, such as mspA, □-hemolysin and porin, are described in Kasianowiscz et al., 1996, Proc Natl Acad Sci USA 93:13770-13773; Howorka et al., 2001, Nature Biotechnol. 18:1091-5; Szabo et al., 1998, FASEB J. 12:495-502; and U.S. Pat. Nos. 5,795,782, 6,015,714, 6,267,872, and 6,428,959; all publications incorporated herein by reference.

In some embodiments, analysis of sequencing products is carried out by translocating the products through a pore fabricated from non-biological materials. Pores, including channels, can be made from a variety of solid state materials using a number of different techniques, including, among others, chemical deposition, electrochemical deposition, electroplating, electron beam sculpting, ion beam sculpting, nanolithography, chemical etching, laser ablation, and other methods well known in the art (see, e.g., Li et al., 2001, Nature 412:166-169; and WO 2004/085609). Solid state materials include, by way of example and not limitation, any known semiconductor materials, insulating materials, and metals. Thus, the solid state pores can comprise without limitation silicon, silicon, silicon nitride, germanium, gallium arsenide, metals (e.g., gold, silver, platinum), metal oxides, and metal colloids. To prepare a pore of appropriate dimensions, various feedback procedures can be employed in the fabrication process. In embodiments where ions pass through a hole, detecting ion flow through the solid state material provides a way of measuring pore size generated during fabrication (see, e.g., U.S. Published Application No. 2005/0126905). In other embodiments, where the electrodes define the size of the pore, electron tunneling current between the electrodes can provide information on the gap size. Increases in tunneling current indicate a decrease in the gap distance between the electrodes. Other feedback techniques will be apparent to the skilled artisan. In some embodiments, the pore can be fabricated using ion beam sculpting, as described in Li et al., 2003, Nature Materials 2:611-615. In the described process, a layer of low stress silicon nitride film is deposited onto a silicon substrate via low pressure chemical vapor deposition. A combination of photolithography and chemical etching can be used to remove the silicon substrate to leave behind the silicon nitride layer. To form the pore, a focused ion beam (e.g., argon ion beam of energy 0.5 to 5.0 Kev and diameter 0. 1 to 0.5 mm) is used to generate a hole in the silicon nitride membrane. By suitable adjustment of the ion beam parameters (e.g., total time the silicon nitride is exposed to the ion beam and the exposure duty cycle) and sample temperature, material can be either removed to enlarge the hole or material added to decrease the hole size. Ion beam bombardment at room temperature and low duty cycle results in migration of material into the hole while bombardment at 5° C. and longer duty cycles results in enlargement of the hole. Measuring the amount of ions transmitted through the pore provides a feedback mechanism for precisely controlling the final pore size (Li et al., supra).

To form a pore of appropriate dimensions, a hole larger than the final desired pore dimensions can be made using sculpting parameters that result in loss of the silicon nitride. Subsequently, the size of the pore can be adjusted to an appropriate dimension using sculpting parameters that result in movement of material into the initially formed hole. In other embodiments, the pores can be made by a combination of electron beam lithography and high energy electron beam sculpting (see, e.g., Storm, et al., 2003, Nature Materials 2:537-540). A silicon-on-insulator, fabricated according to known methods, can be used to form a silicon membrane, which is then oxidized to form a silicon oxide layer. Using a combination of electron-beam lithography and anisotropic etching, the silicon oxide is removed to expose the silicon layer. Holes are made in the silicon by KOH wet etching and the silicon oxidized to form a silicon oxide layer of sufficient depth, such as for example a layer of about 40 um. Exposure of the silicon dioxide to a high energy electron beam (e.g., from a transmission electron microscope) deforms the silicon dioxide layer surrounding the hole. Whether the initial holes are enlarged or decreased depends on the initial size. Holes 50 nm or smaller appear to decrease in size while holes of about 80 nm or larger increase in size. A similar approach for generating a suitable pore by ion beam sputtering technique is described in Heng et al., 2004, Biophy J 87:2905-2911. In this technique, the pores are formed using lithography with a focused high energy electron beam on metal oxide semiconductor (CMOS) combined with general techniques for producing ultrathin films. In other embodiments, the pore can be constructed as described in U.S. Pat. No. 6,627,067; 6,464,842; 6,783,643, and U.S. Publication No. 2005/0006224 by sculpting of silicon nitride. Initially, a layer of silicon nitride is deposited on both sides of a silicon layer by chemical vapor deposition. Following addition of a photoresist in a manner that leaves a portion of the silicon nitride layer exposed, the exposed silicon nitride layer on one side is removed by conventional ion etching techniques so leave behind a silicon coated with silicon nitride on the other side. The silicon can be removed by any number of etching techniques, such as by anisotropic KOH etching, thus leaving behind a membrane of silicon nitride. The thickness of the silicon nitride membrane can be controlled by adjusting the thickness deposited onto the silicon. By use of electron beam lithography or photolithography, a cavity is produced on one side of the silicon nitride layer followed by thinning of the membrane on the other side of the cavity. Suitable thinning processes include, among others, ion beam sputtering, ion beam assisted etching, electron beam etching, and plasma reactive etching. Numerous variations on this fabrication process, for example, use of silicon nitride layer sandwiched between two silicon layers, can be used to generate different sized pores. As noted above, a feedback mechanism based on measuring the rate and/or intensity of ions passing through the pore provides a method of controlling the pore size during the fabrication process. In other embodiments, the pore can be constructed as a gold or silver nanotube. In some embodiments, these pores are formed using a template of porous material, such as polycarbonate filters prepared using a track etch method, and depositing gold or other suitable metal on the surface of the porous material. Track etched polycarbonate membranes are typically formed by exposing a solid membrane material to high energy nuclear particles, which creates tracks in the membrane material. Chemical etching is then employed to convert the etched tracks to pores. The formed pores have a diameter of about 10 nm and larger. Adjusting the intensity of the nuclear particles controls the density of pores formed in the membrane.

Nanotubes can be formed on the etched membrane by depositing a metal, typically gold or silver, into the track etched pores via an electro less plating method (Menon et al., 1995, Anal Chem 67:1920-1928). This metal deposition method uses a catalyst deposited on the surface of the pore material, which is then immersed into a solution containing Au(I) and a reducing agent. The reduction of Au(I) to metallic Au occurs on surfaces containing the catalyst. Amount of gold deposited is dependent on the incubation time such that increasing the incubation time decreases the inside diameter of the pores in the filter material. Thus, the pore size can be controlled by adjusting the amount of metal deposited on the pore. The resulting pore dimension is measured using various techniques, for instance, gas transport properties using simple diffusion or by measuring ion flow through the pores using patch clamp type systems. The support material is either left intact, or removed to leave gold nanotubes. Electroless plating technique is capable of forming pore sizes from less than about 1 nm to about 5 nm in diameter, or larger as required. Gold nanotubes having pore diameter of about 0.6 nm appears to distinguish between Ru(bpy)2+2 and methyl viologen, demonstrating selectivity of the gold nanopores (Jirage et al., 1997, Science 278:655-658). Modification of a gold nanotube surface is readily accomplished by attaching thiol containing compounds to the gold surface or by derivatizing the gold with other functional groups. This features permits attachment of pore modifying compounds. Devices, such as the cis/trans apparatuses used with the biological pores described herein, can also be used with the gold nanopores to analyze binding reactions.

Where the detection is based on imaging of charge induced field effects, a semiconductor device can be fabricated as described in U.S. Pat. No. 6,413,792 and U.S. published application No. 2003/0211502. The methods of fabricating these detection devices can use techniques similar to those employed to fabricate other solid state pores. In some embodiments, the field effect detector is made using a silicon-on-insulator that comprises a silicon substrate with a silicon dioxide layer and a p-type silicon layer (doped silicon in which the majority of the charge carriers are positively charged holes). A shallow n-type silicon (doped silicon in which the majority of the charge carriers are negatively charged holes) layer is formed in the p-type silicon layer by ion implantation and addition of an n-type dopant, while another n-type silicon layer that extends through the p-type silicon layer is formed on another region of the silicon-on-insulator. Removal of the silicon substrate and silicon dioxde layers by etching exposes the p-type silicon on the face opposite to the first formed shallow n-type layer. On the newly exposed face of the p-type silicon, a second shallow n-type silicon layer is formed, which connects to the n-type silicon layer that extends through the p-type silicon layer. For analyzing the binding reaction, a pore that extends through the two shallow n-type silicon layers and the p-type silicon layer is generated by various techniques, for example by ion etching or lithography (e.g., optical or electron beam). To decrease the pore size, a silicon dioxide layer can be formed by oxidizing the silicon. Metal layers are attached so the first formed n-type silicon layer and the n-type silicon layer that extends through p-type silicon, thereby forming the source and drain regions.

In the various embodiments herein lot the analysis of the sequencing reaction products, the pore can be configured in various formats. in some embodiments, the device comprises a membrane, either biological or solid state, containing the pore held between two reserviors, also referred to as cis and trans chambers (see, e.g., U.S. Pat. No. 6,627,067). A conduit for electron migration between the two chambers allows electrical contact of the two chambers, and a voltage bias between the two chambers can direct translocation of the products through the pore. A variation of this configuration is used in the analysis of current flow through biological nanopores, as described in U.S. Pat. Nos. 6,015,714 and 6,428,959; and Kasianowiscz et al., 1996, Proc Natl Acad Sci USA 93: 13770-13773, the disclosures of which are incorporated herein by reference. Variations of the device above are also disclosed In U.S. application publication no. 2003/0141189. In these embodiments, a pair of nanoelectrodes fabricated by electrodeposition is positioned on a substrate surface. The electrodes face each other and have a gap distance sufficient for passage of the product to be analyzed. An insulating material protects the nanoelectrodes, exposing only the tips of the electrodes for purposes of detection. The insulating material and nanoelectrodes separate a chamber serving as a sample reservoir and a chamber to which the product to be analyzed is delivered by translocation. Cathode and anode electrodes provide an electric field for directing translocation from the sample chamber to the delivery chamber. The current bias used to direct translocation through the pore can be generated by applying an electric field through the pore. In some embodiments, the electric field is a constant voltage or constant current bias. In other embodiments, the translocation of the products can be controlled through a pulsed operation of the electrophoresis electric field parameters (see, e.g., U.S. Patent Application No 20031141189 and U.S. Pat. No. 6,627,067). Pulses of current can provide a method of precise translocation for a defined time period through the pore and, in some instances, to briefly hold the product within the pore, and thereby provide greater resolution of the electrical properties of the product being analyzed.

A sequencing device comprising: a) a nanopore layer comprising an array of nanopores, each nanopore having a cross sectional dimension of 1 to 10 nanometers, and having a top and a bottom opening, wherein the bottom opening of each nanopore opens into a discrete reservoir, resulting in an array of reservoirs, wherein each reservoir comprises one or more electrodes, the nanopore layer physically and electrically connected to a semiconductor chip, and b) the semiconductor chip, comprising an array of circuit elements, wherein each of the electrodes in the array of reservoirs is connected to at least one circuit element on the semiconductor chip. In some aspects, the invention provides a device for determining sequence information comprising: a substrate comprising an array of nanopores; each nanopore fluidically connected to an upper fluidic region and a lower fluidic region; wherein each upper fluidic region is fluidically connected through an upper resistive opening to an upper liquid volume. In some embodiments the upper liquid volume is fluidically connected to two or more upper fluidic regions. In some embodiments each lower fluidic region is fluidically connected through a lower resistive opening to a lower liquid volume, and wherein the lower liquid volume is fluidically connected to two or more lower fluidic regions. In some embodiments, each nanopore further includes a FRET donor moiety, such as a quantum dot, disposed in or adjacent to for transferring energy to acceptor moieties attached to sequencing reaction products. In some embodiments, such disposition of the FRET donor moiety in or adjacent to a nanopore means that the FRET donor moiety is within a FRET energy transfer distance of at least a portion of the sequencing products as they pass through the nanopore.

In some embodiments the substrate is a semiconductor comprising circuit elements. In some embodiments either the upper fluidic region or the lower fluidic region for each nanopore or both the lower fluidic region and the upper fluidic region for each nanopore is electrically connected to a circuit element. In some embodiments the circuit element comprises an amplifier, an analog-to-digital converter, or a clock circuit.

In some embodiments the resistive opening comprises one or more channels. In some embodiments the length and width of the one or more channels are selected to provide a suitable resistance drop across the resistive opening. In some embodiments the conduit is a channel through a polymeric layer. In some embodiments the polymeric layer is polydimethylsiloxane (PDMS).

In some embodiments the device further comprises an upper drive electrode in the upper liquid volume, a lower drive electrode in the lower liquid volume, and a measurement electrode in either the upper liquid volume or the lower liquid volume. In some embodiments the device further comprises an upper drive electrode in the upper liquid volume, a lower drive electrode in the lower liquid volume, and an upper measurement electrode in the upper liquid volume and a lower measurement electrode in the lower liquid, volume. In some embodiments the nanopore, upper fluidic reservoir and lower fluidic reservoir are disposed within a channel that extends through the substrate. In some embodiments the upper fluidic reservoir and lower fluidic reservoir each open to the same side of the substrate.

In some aspects, the invention provides a sequencing, device comprising: a) a nanopore layer comprising an array of nanopores, each nanopore having a cross sectional dimension of 1 to 10 nanometers, and having a top and a bottom opening, wherein the bottom opening of each nanopore opens into a discrete reservoir, resulting in an array of reservoirs, wherein each reservoir comprises one or more electrodes, the nanopore layer physically and electrically connected to a semiconductor chip, and b) the semiconductor chip, comprising an array of circuit elements, wherein each of the electrodes in the array of reservoirs is connected to at least one circuit element on the semiconductor chip.

In some embodiments the array of nanopores comprises an array of holes in a solid substrate, each hole comprising a protein nanopore. In some embodiments each protein nanopore is held in place in its bole with a lipid bilayer. In some embodiments the top opening of the nanopores open into an upper reservoir. In some embodiments the circuit elements comprise amplifiers, analog to digital converters, or clock circuits. In some aspects, the invention provides a method of fabricating a sequencing device comprising: a) obtaining a semiconductor substrate; b) processing the semiconductor substrate to create an array of microfluidic features, wherein the microfluidic features are capable of supporting an array of nanopores; e) subsequently producing circuit elements on the substrate that are electronically coupled to the microfluidic features: and d) introducing nanopores into the microfluidic features. In some embodiments the circuit elements are CMOS circuit elements. In some embodiments the CMOS circuit elements comprise amplifiers, analog to digital converters.

In some aspects, the invention provides a method of fabricating a sequencing device comprising the following steps in the order presented: a) obtaining a semiconductor substrate; b) processing the semiconductor substrate to create an array of CMOS circuits, without carrying out an aluminum deposition step; c) processing the semiconductor substrate having the CMOS circuits to produce microfluidic features, wherein the microfluidic features are capable of supporting nanopores; d) subsequently performing an aluminum deposition step to create conductive features; and e) introducing nanopores into the microfluidic features. In some embodiments the processing of step (c) to create the microfluidic features subjects the semiconductor substrate to temperatures greater than about 250° C. In some aspects, the invention provides a method for fabricating a sequencing device comprising: a) producing an insulator layer having microfluidic elements comprising an array of pores extending through the insulator; b) bonding the insulator layer with a semiconductor layer; c) exposing the semiconducting layer to etchant through the pores in the insulator layer to produce discrete reservoirs in the semiconductor layer; d) removing portions of the semiconductor layer to isolate the discrete reservoirs from one another, e) incorporating electrical contacts into the semiconductor layer that allow current to be directed to each of the discrete reservoirs; and f) bonding an electric circuit layer to the semiconducting layer such that the electric circuits on the electric circuit layer are electrically connected to the electrical contacts on the semiconductor layer.

In some embodiments the method further comprises the step of adding nanopores into each of the pores. In some embodiments the method further comprises two or more electrodes within each of the discrete reservoirs. In some aspects, the invention provides a method for fabricating a sequencing device comprising: a) producing an insulator layer having microfluidic elements comprising an array of pores extending through the insulator; b) bonding the insulator layer with a semiconductor layer wherein the semiconducting layer comprises an array of wells corresponding to the pores on the insulator layer, whereby the bonding produces an array of discrete reservoirs, each discrete reservoir connected to a pore; c) removing portions of the semiconductor layer to isolate the discrete reservoirs from one another d) adding electrical contacts to the semiconductor layer that allow current to be directed to each of the discrete reservoirs; and e) bonding an electric circuit layer to the semiconducting layer such that the electric circuits on the electric circuit layer are electrically connected to the electrical contacts on the semiconductor layer.

In some aspects, the invention provides a method for fabricating a sequencing device comprising: a) obtaining an SOI substrate comprising a top silicon layer, an insulator layer, and a bottom silicon layer; b) processing the top silicon layer and bottom silicon layer to remove portions of each layer to produce an array of exposed regions of the insulator layer in which both the top and bottom surfaces of the insulator layer are exposed; c) processing the top silicon layer or the bottom silicon layer or both the top silicon layer and bottom silicon layer to add electrodes and electrical circuits; and d) processing the insulator layer to produce an array of pores through the exposed regions of the insulator layer,

In some embodiments the method further comprises adding polymer layers to the top of the device, the bottom of the device, or to the top and to the bottom of the device to produce microfluidic features. In some embodiments the method further comprises inserting a nanopore into the pores in the insulator layer. In some aspects, the invention provides a method for determining sequence information about a polymer molecule comprising: a) providing a device comprising a substrate having an array of nanopores; each nanopore fluidically connected to an upper fluidic region and a lower fluidic region; wherein each upper fluidic region is fluidically connected through a an upper resistive opening to an upper liquid volume; and each lower fluidic region is connected to a lower liquid volume, and wherein the upper liquid volume and the lower liquid volume are each fluidically connected to two or more fluidic regions, wherein the device comprises an upper drive electrode in the upper liquid volume, a lower drive electrode in the lower liquid volume, and a measurement electrode in either the upper liquid volume or the Sower liquid volume; b) placing a polymer molecule to be sequenced into one or more upper fluidic regions; c) applying a voltage across the upper and lower drive electrodes so as to pass a current through the nanopore such that the molecule is translated through the nanopore; d) measuring the current through the nanopore over time; and e) using the measured current over time in step (d) to determine sequence information about the molecule. In some embodiments the substrate comprises electronic circuits electrically coupled to the measurement electrodes which at least partially process signals from the measurement electrodes. In some embodiments the upper drive electrode and lower drive electrode are each biased to a voltage above or below ground, and at least a portion of the substrate electrically connected to the electronic circuits is held at ground potential.

In some aspects, the invention provides a method for determining sequence information about a polymer molecule comprising: a) providing a device having an array of nanopores, each connected to upper and lower fluid regions; wherein the device comprises electronic circuits electrically connected to electrodes in either the upper fluid regions or lower fluid regions or both the upper and lower fluid regions; b) placing a polymer molecule in an upper fluid region; c) applying a voltage across the nanopore whereby the polymer molecule is translocated through the nanopore: d) using the electronic circuits to monitor the current through the nanopore over time, wherein the electronic circuits process the incoming current over time to record events, thereby generating event data; and e) using the event data from step (d) to obtain sequence information about the polymer molecule. In some embodiments the events comprise a change in current level above or below a specified threshold. In some embodiments the electronic circuit records the events, the average current before the events and the average current after the events. In some embodiments the event data is generated without reference to time. In some embodiments a clock circuit is used such that the relative time that the events occurred is also determined. In some embodiments the event data generated by the electronic circuits on the device is transmitted from the device for further processing. In some embodiments the information is transmitted optically.

The invention relates to devices, systems, and methods for sequencing polymers using nanopores. In particular, the invention relates to multiplex sequencing in which sequencing data is simultaneously obtained from multiple nanopores. In some aspects, the invention relates to multiplex nanopore sequencing devices that directly incorporate semiconductor devices, such as CMOS devices. The devices of the invention can be made wherein the nanopores are formed in a semiconductor substrate, such as silicon. Alternatively, the devices can be made in a composite semiconductor substrate such as silicon-insulator-silicon (SOI), or can be made by bonding together semiconductor and insulator components. The incorporation of semiconductors such as silicon into the devices provides for the inclusion of electronic circuitry in close association with the nanopores. For example, the use of silicon allows for a multiplex device having an array of electronic circuits wherein each nanopore in the array is directly associated with, a set of electronic circuits. These circuits can provide the functions of measurement, data manipulation, data storage, and data transfer. The circuits can provide amplification, analog to digital conversion, signal processing, memory, and data output.

In some aspects, the invention relates to devices and methods which allow for multiplex electronic sequencing measurements in a manner that reduces or eliminates cross-talk between the nanopores in the nanopore array. In some cases it is desirable for a nanopore sequencing measurement system to have a pair of drive electrodes that drive current through the nanopores, and one or more measurement electrodes that measure the current through the nanopore. It can be desirable to have the drive electrodes drive current through multiple nanopores in the nanopore array, and have measurement electrodes that are directly associated with each nanopore. We have found that this type of system can be obtained by the incorporation of resistive openings, which connect a reservoir of fluid in contact with the nanopore to a volume of fluid in contact with a drive electrode in a manner that creates a resistive drop across the resistive opening, but allows for fluidic connection and for ion transport between the reservoir of fluid in contact with the nanopore and the volume of fluid in contact with the drive electrode.

The resistive opening can be made from any suitable structure that provides for a resistive drop across two fluid regions while allowing for the passage of fluid including ions between the fluid, regions. In general, the resistive opening will impede, but not prevent the flow of ions. The resistive opening can comprise, for example, one or more narrow holes, apertures, or conduits. The resistive opening can comprise a porous or fibrous structure such as a nanoporous or nanofiber material. The resistive opening cart comprise a single, or multiple, long, narrow channels. Such channels can be formed, for example, in a polymeric material such its polydimethylsiloxane (PDMS). The invention relates in some aspects to devices for multiplex nanopore sequencing. In some cases, the devices of the invention comprise resistive openings between fluid regions in contact with the nanopore and fluid regions which house a drive electrode. The devices of the invention can be made using a semiconductor substrate such as silicon to allow for incorporated electronic circuitry to be located near each of the nanopores or nanometer scale apertures in the array of nanopores which comprise the multiplex sequencing device. The devices of the invention will therefore comprise arrays of both microfluidic and electronic elements. In some cases, the semiconductor which has the electronic elements also includes microfluidic elements that contain the nanopores. In some cases, the semiconductor having the electronic elements is bonded to another layer which has incorporated microfluidic elements that contain the nanopores.

The devices of the invention generally comprise a microfluidic element into which a nanopore is disposed. This microfluidic element will generally provide for fluid regions on either side of the nanopore through which the molecules to be detected for sequence determination will pass. In some cases, the fluid regions on either side of the nanopore are referred to as the cis and trans regions, where the molecule to be measured generally travels from the cis region to the trans region through the nanopore. For the purposes of description, we sometimes use the terms upper and lower to describe such reservoirs and other fluid regions. It is to be understood that the terms upper and lower are used as relative rather than absolute terms, and in some cases, the upper and lower regions may be in the same plane of the device. The upper and lower fluidic regions are electrically connected either by direct contact, or by fluidic (ionic) contact with drive and measurement electrodes. In some cases, the upper and lower fluid regions extend through a substrate, in other cases, the upper and lower fluid regions are disposed within a layer, for example, where both the upper and lower fluidic regions open to the same surface of a substrate. Methods for semiconductor and microfluidic fabrication described herein and as known in the art can be employed to fabricate the device of the invention.

Devices of the invention can have any suitable number of pores to facilitate multiplex sequencing, for example 2 to 10 pores, 10 to 100 pores, 100 to 1000 pores, 1000 to 10,000 pores or more than 10,000 pores. Each of the pores has a nanopore or nanometer scale aperture 150. As used herein the term nanopore, nanometer scale aperture, and nanoscale aperture are used interchangeably. In each case, the term refers to an opening which is of a size such that when molecules of interest pass through the opening, the passage of the molecules can be detected by a change in signal, for example, electrical signal, e.g. current. In some cases the nanopore comprises a protein, such as alpha-hemolysin or MspA, which can be modified or unmodified. In some cases, the nanopore is disposed within a membrane, or lipid bilayer, which can be attached to the surface of the microfluidic region of the device of the invention by using surface treatments as described herein and as known in the art. In some cases, the nanopore can be a solid state nanopore. Solid state nanopores can be produced as described in U.S. Pat. No. 7,258,838, U.S. Pat. No. 7,504,058 In some cases, the nanopore comprises a hybrid protein/solid state nanopore in which a nanopore protein is incorporated into a solid state nanopore.

One aspect of the invention is the use of a hybrid solid state-protein nanopore in the multiplexed nanopore sequencing device. We describe herein methods for functionalizing a solid-state pore either to enhance its ability to detect or sequence a polymer such as DNA, or to enable hybrid protein/solid state nanopore. In such a hybrid, the solid-state pore acts a substrate with a hole for the protein nanopore, which would be positioned as a plug within the hole. The protein nanopore would perform the sensing of DNA molecules. This hybrid can the advantages of both types of nanopores: the possibility for batch fabrication, stability, compatibility with micro-electronics, and a population of identical sensing summits. Unlike methods where a lipid layer much larger than the width of a protein nanopore is used, the hybrid nanopores are generally constructed such that the dimensions of the solid state pore are close to the dimensions of the protein nanopore. The solid state pore into which the protein nanopore is disposed is generally from about 20% larger to about three times larger than the diameter of the protein nanopore. In preferred embodiments the solid state pore is sized such that only one protein nanopore will associate with the solid state pore. An array of hybrid nanopores is generally constructed by first producing an array of solid state pores in a substrate, selectively functionalizing the nanopores for attachment of the protein nanopore, then coupling or conjugating the nanopore to the walls of the solid state pore using liker/spacer chemistry.

One aspect of the invention comprises the use of surface monolayers on a solid state pore. In some embodiments, SiN substrates are treated using functional methoxy-, ethoxy-, or chloro-organosilane(s) such as —NHS terminated, —NH2 (amine) terminated, carboxylic acid terminated, epoxy terminated, maleimide terminated, isothiocyanate terminated, thiocyanate terminated, thiol terminated, meth(acrylate) terminated, azide, or biotin terminated. These functional groups for the non-specific immobilization of aHL or another protein. In some cases, S1 is functionalized to have only passive, inactive functional groups on the S1 surface. These functional groups can include polymeric chains at controlled length to prevent non-specific adsorption of biological species and reagents across the S1 surface. Some examples of these functional groups are PEG, fluorinated polymers, and other polymeric moieties at various molecular weights. This chemistry is schematically illustrated as (X) and typically provides a passive layer to prevent non-specific noise throughout the detection signal of the hybrid nanopore. In some embodiments, SiOx substrates are treated using functional organosilane(s) such as —NHS terminated, —NH2 (amine) terminated, carboxylic acid terminated, epoxy terminated, maleimide terminated, isothiocyanate terminated, thiocyanate terminated, thiol terminated, meth(acrylate) terminated, azide, or biotin terminated. These functional groups are useful for non-specific immobilization of aHL or another protein. For specific control over location and conformation of such proteins inside a hybrid nanopore, S1 can be functionalized to have only passive, inactive functional groups on the S1 surface. These functional groups may include polymeric chains at controlled length to prevent non-specific adsorption of biological species and reagents across the S1 surface. Some examples of these functional groups are PEG, fluorinated polymers, and other polymeric moieties at various molecular weights. This chemistry is schematically illustrated as (X) and typically provides a passive layer to prevent non-specific noise throughout the detection signal of the hybrid nanopore. In some embodiments, ALD alumina (as substrate) is modified using phosphonate chemistry. This includes phosphate, sulfonate, and silane chemistries since they all have weak affinities towards AlOx surfaces as well. The phosphonates can have any of the above chemistries on the terminus for surface treatment.

Where gold is the substrate, the invention comprises the use of functionalized thiol chemistries. The S2 layer is positioned to control the depth as which the protein or biological of choice is immobilized within the hybrid nanopore. The distance e in the figure controls the spacing of the linker/spacer such as a protein within the hybrid nanopore. The size of the liker/spacer can be adjusted by selecting the appropriate polymeric or rigid chemical spacer length of the linker between S2 and the protein attachment point. For example, this parameter can be controlled via the molecular weight and rigidity of the polymeric or non-polymeric linker chemistry used. Also, this can be controlled by the S2 electrode protrusion into hybrid nanopore. The linker chemistry used to attach alpha-HL or another protein to the hybrid nanopore sidewall substrate can consist of the pendant groups mentioned above, but may or may not also include a polymeric or rigid linker that further positions the protein into the center of the nanopore. This linker can distance can be controlled via control over the molecular weight and chemical composition of this linker. Some examples can include polypeptide linkers as well as PEG linkers.

The chemistries described above can be used as a conjugation mechanism for attachment of large molecule sensors such as proteins or quantum dots or functionalized vital templates or carbon nanotubes or DNA, if the nanopore is 10s-100s of nanometers in diameter. These large molecule sensors can be used to optically or electrochemically enhance detection via molecule-DNA interactions between H-bonds, charge, and in the case of optical detection via a FRET, quenching, or fluorescence detection event. For example, if the nanopores are about 1 nm to 3 nm in diameter, the acid terminated silanes can be used to functionalize pores for better control over DNA translocation. Further, PEGylatioa with short PEGs may allow for passivation of pores to allow for ease of translocation. In some embodiments, the invention provides surface chemistries for the attachment of proteins such as alpha-hemolysin to the solid state pore surface. Functional surface chemistries described above can be used to either A) conjugate protein via an engineered or available peptide residue to the nanopore surface, to anchor the protein or B) to functionalize the surface chemistry such that the hydrophilic region of that chemistry is presented to the surface to facilitate lipid bi-layer support. White et al., J. Am. Chem. Soc., 2007, 129 (38), 11766-11775, show this using cyano-functionalized surfaces, but any hydrophilic surface chemistry such as cyano-, amino-, or PEG terminated chemistries should support this function. Specifically, the covalent conjugation of alpha hemolysin (or other proteins) to the surface of a solid state pore can be achieved via cystine or lysine residues in the protein structure. Further conjugation could be achieved via engineered peptide sequences in the protein structure or through CLIP or SNAP (Covalys) chemistries that are specific to one and only one residue engineered onto the protein structure. In more detail, protein lysine residues can be conjugated to NHS-containing chemistries, cystine residues to maleimide containing surface chemistries or SNAP to benzyl guanine/SNAP tags introduced onto the protein and CLIP to benzyl cytosine tags introduced onto the protein of choice.

As described above, the hybrid nanopores of the present invention are generally prepared such that only a single protein nanopore will associate with each solid state pore by appropriately sizing the solid state pore and by using linker/spacer chemistry of the appropriate dimensions, in some cases, the solid state pores can accommodate more than one protein nanopore, and other approaches are used to ensure that only one protein nanopore is loaded into one pore, hole, or aperture in the device. Both the hybrid nanopores described above and the other nanopores used herein can include the use of a lipid layer for supporting the protein nanopore and acting as a spacer within the solid state pore, in some cases loading can be done at a concentration at which a Poisson distribution dictates that at most about 37% of the apertures will have a single nanopore. Measurements on the pores will reveal which of the pores in the array have a single protein nanopore, and only those are used for sequencing measurements. In some cases loadings of single protein nanopores higher than that obtained through Poisson statistics are desired.

In some cases, repeated loading at relatively low concentrations can be used in order improve fraction of single protein nanopores. Where each of the pores can be addressed independently with a drive voltage, each pore could be connected to a fluidic conduit that supplies protein nanopores at a low concentration to the solid state pores, where the each conduit has a valve which can be controlled to allow or shut of the Slow of fluid. The current across the solid state pore is monitored while the flow of fluid is enabled. Measurement of current while loading a lipid bilayer has been shown, see, e.g. JACS, 127:6502-6503 (2005) and JACS 129:4701-4705 (2007). When a protein nanopore becomes associated with the nanopore, a characteristic current/voltage relationship will indicate that a single pore is in place. At the point that a protein nanopore is associated, the flow of the liquid is interrupted to prevent further protein nanopore additions. The system can additionally be constructed to apply an electrical pulse that will dislodge the protein nanopore from the solid state pore where the electronics indicates that more than one protein nanopore has been incorporated. Once the multiple protein nanopores are removed, the flow of protein nanopores to the solid state pore can be resumed until a single protein nanopore is detected. These systems can be automated using feedback to allow the concurrent loading of multiple wells in the array without active user intervention during the process.

In some cases, steric hindrance can be used so ensure that a single protein nanopore is loaded into a single solid slate pore. For example each protein nanopore can be attached to a sizing moiety that the size of the protein nanopore and the sizing moiety is such that only one will fit into each solid state pore. The sizing moiety can comprise, for example, one or more of a head, nanoparticle, dendrimers, polymer, or DNA molecule whose size is on the order of the region between the protein nanopore and the solid state pore. These methods can be used in combination with membranes such as lipid bilayers. In some cases, the sizing moieties are removed after loading and before measurement. Alternatively, in some cases, the sizing moieties can remain associated with the protein nanopores after loading. In some embodiments, multiple sizing moieties are employed. Where membranes such as lipid bilayers are employed, each protein nanopore can be functionalized with arms, e.g. dendrimers-like arms, each having a membrane inserting moiety at its end (for example a non-porous transmembrane protein). The membrane inserting moieties will prevent the association of a second protein nanopore complex, from entering the bilayer.

Labeled Nanopores and FRET Detection

Generation and detection of FRET signals for detecting sequencing products are carried out as described in Huber, International patent publication WO 2011/040996; Russell, U.S. Pat. No. 6,528,258; Joyce, U.S. patent publication 2006/0019259; Pittaro et al, U.S. patent publication 2005/0095S99; and the like, which are each incorporated herein by reference. Methods and systems for sequencing a nucleic acid are provided. One or more donor labels, which are positioned on, attached or connected to a pore or nanopore, may be illuminated or otherwise excited. A sequencing reaction product (or equivalently “byproduct”) labeled with one or more acceptor labels, may be translocated through the nanopore. Either before, after or while the labeled sequencing reaction product or molecule passes through, exits or enters the nanopore and when an acceptor label comes into FRET proximity with a donor label, energy may be transferred from the excited donor label to the acceptor label of the product. As a result of the energy transfer, the acceptor label emits energy, and the emitted energy is detected or measured in order to identify the product. A nucleic acid or other polymer may be deduced, i.e. sequenced, based on the sequence of detected or measured energy emission from the acceptor labels of the products of a sequencing reaction.

A labeled sequencing reaction product may be translocated through the nanopore and upon entering, exiting or while passing through the nanopore such labeled product comes in close proximity to the nanopore or donor label. For example, within 1-10 nm or 1-2 nm of the nanopore donor label. The donor labels may be continuously illuminated with radiation of appropriate wavelength to excite the donor labels. Via a dipole-dipole energy exchange mechanism called FRET (Stryer, L. Annu Rev Biochem. 47 (1978): 819-846), the excited donor labels transfer energy to a bypassing nucleic acid or acceptor label. The excited acceptor label may then emit radiation, e.g., at a lower energy than the radiation that was used to excite the donor label. This energy transfer mechanism allows the excitation radiation to be “focused” to interact with the acceptor labels with sufficient resolution to generate a signal at the single nucleotide scale.

A pore may have two sides. One side is referred to as the “cis” side and faces the (−) negative electrode or a negatively charged buffer/ion compartment or solution. The other side is referred to as the “trans” side and faces the (+) electrode or a positively charged buffer/ton compartment or solution. A biological polymer, such as a labeled nucleic acid molecule or polymer can be pulled or driven through the pore by an electric field applied through the nanopore, e.g., entering on the cis side of the nanopore and exiting on the trans side of the nanopore.

A nanopore or pore may be labeled with one or more donor labels. For example, the cis side or surface and/or trans side or surface of the nanopore may be labeled with one or more donor labels. The label may be attached to the base of a pore or nanopore or to another portion or monomer making up the nanopore or pore A label may be attached to a portion of the membrane or substrate through which a nanopore spans or to a linker or other molecule attached to the membrane, substrate or nanopore. The nanopore or pore label may be positioned or attached on the nanopore, substrate or membrane such that the pore label can come into proximity with an acceptor label of a biological polymer, e.g., a nucleic acid, which is translocated through the pore. The donor labels may have the same or different emission or absorption spectra.

A pore label may include one or more quantum dots. A quantum dot has been demonstrated to have many or all of the above described properties and characteristics found in suitable pore labels (Bawendi M. G. in U.S. Pat. No. 6,2 1,303). Quantum dots are nanometer scale semiconductor crystals that exhibit strong quantum confinement due to the crystals radius being smaller than the Bohr exciton radius. Due to the effects of quantum confinement, the bandgap of the quantum dots increases with decreasing crystal size thus allowing the optical properties to be tuned by controlling the crystal size (Bawendi M. G. et al., in U.S. Pat. No. 7,235,361 and Bawendi M. G. et al., in U.S. Pat. No. 6,855,551).

One example of a quantum dot which may be utilized as a pore label is a CdTe quantum dot which can be synthesized aqueously. A CdTe quantum dot may be functionalized with a nucleophilic group such as primary amines, thiols or functional groups such as carboxylic acids. A CdTe quantum dot may include a mercaptopropionic acid capping ligand, which has a carboxylic acid functional group that may be utilized to covalently link a quantum dot to a primary amine on the exterior of a protein pore. The cross-linking reaction may be accomplished using standard cross-linking reagents (homo-bifunctional as well as hetero-bifunctional) which are known to those having ordinary skill in the art of bioconjugation. Care may be taken to ensure that the modifications do not impair or substantially impair the translocation of a nucleic acid through the nanopore. This may be achieved by varying the length of the employed crosslinker molecule used to attach the donor label to the nanopore.

The primary amine of the Lysin residue 131 of the natural alpha hemolysin protein (Song. L. et al., Science 274, (1096): 1859-1566) may be used to covalently bind carboxy modified CdTe Quantum dots via 1-Ethyl-3-[3-dimethylaminopropyl]carbodiimide hydrochloride/N-hydroxysulfosuecinim.de (EDC/NHS) coupling chemistry.

A method for sequencing a polymer, such as a nucleic acid molecule includes providing a nanopore or pore protein (or a synthetic pore) inserted in a membrane or membrane like structure or other substrate. The base or other portion of the pore may be modified with one or more pore labels. The base may refer to the Trans side of the pore. Optionally, the cis and/or trans side of the pore may be modified with one or more pore labels. Nucleic acid polymers to be analyzed or sequenced may be used as a template for producing a labeled version of the nucleic acid polymer, to which one of the four nucleotides or up to all four nucleotides in the resulting polymer is/are replaced with the nucleotide's labeled analogue(s). An electric field is applied to the nanopore which forces the labeled nucleic acid polymer through/the nanopore, while an external monochromatic or other light source may be used to illuminate the nanopore, thereby exciting the pore label. As, after or before labeled nucleotides of the nucleic acid pass through, exit or enter the nanopore, energy is transferred from the pore label, to a nucleotide label, which results in emission of lower energy radiation. The nucleotide label radiation is then detected by a confocal microscope setup or other optical detection system or light microscopy system capable of single molecule detection known to people having ordinary skill in the art. Examples of such detection systems include but are not limited to confocal microscopy, epifluoroescent microscopy and total internal reflection fluorescent (TIRF) microscopy. Other polymers (e.g., proteins and polymers other than nucleic acids) having labeled sequencing reaction products may also be sequenced according to the methods described herein.

Energy may be transferred from a pore or nanopore donor label (e.g., a quantum dot) to an acceptor label on a polymer (e.g., a nucleic acid) when an acceptor label of an acceptor labeled product (e.g., nucleotide) of the polymer interacts with the donor label as, after or before the labeled product exits, enters or passes through a nanopore. For example, the donor label may be positioned on or attached to the nanopore on the cis or trans side or surface of the nanopore such that the interaction or energy transfer between the donor label and acceptor label does not take place until the labeled product exits the nanopore and comes into the vicinity or proximity of the donor label outside of the nanopore channel or opening. As a result, interaction between the labels, energy transfer from the donor label to the acceptor label, emission of energy front the acceptor label and/or measurement or detection of an emission of energy from the acceptor label may take place outside of the passage, channel or opening running through the nanopore, e.g., within a cis or trans chamber on the cis or trans sides of a nanopore. The measurement or detection of the energy emitted from the acceptor label of a product may be utilized to identify the product.

The nanopore label may be positioned outside of the passage, channel or opening of the nanopore such that the label may be visible or exposed to facilitate excitation or illumination of the label. The interaction and energy transfer between a donor label and accepter label and the emission of energy from the acceptor label as a result of the energy transfer may take place outside of the passage, channel or opening of the nanopore. This may facilitate ease and accuracy of the detection or measurement of energy or light emission from the acceptor label, e.g., via an optical detection or measurement device. The donor and acceptor label interaction may take place within a channel of a nanopore and a donor label could be positioned within the channel of a nanopore.

A donor label may be attached in various manners and/or at various sites on a nanopore. For example, a donor label may be directly or indirectly attached or connected to a portion or unit of the nanopore. Alternatively, a donor label may be positioned adjacent to a nanopore. During sequencing of a nucleic acid molecule, the energy transfer signal may be generated with sufficient intensity that a sensitive detection system can accumulate sufficient signal within the transit time of a single nucleotide through the nanopore to distinguish a labeled nucleotide from an unlabeled nucleotide. Therefore, the pore label may be stable, have a high absorption cross-section, a short excited state lifetime, and/or temporally homogeneous excitation and energy transfer properties. The nucleotide label may be capable of emitting and absorbing sufficient radiation to be detected during the transit time of the nucleotide through me pore. The product of the energy transfer cross-section, emission rate, and quantum yield of emission may yield sufficient radiation intensity for detection within the single nucleotide transit time. A nucleotide label may also be sufficiently stable to emit the required radiation intensity and without transience in radiation emission.

The excitation radiation source may be of high enough intensity that when focused to the diffraction limit on the nanoopore, the radiation flux is sufficient to saturate the pore label. The detection system may filter out excitation radiation and pore label emission while capturing nucleic acid label emission during pore transit with sufficient signal-to-noise ratio (S/N) to distinguish a labeled nucleotide from an unlabeled nucleotide with high certainty. The collected nucleic acid label radiation may be counted over an integration time equivalent to the single nucleotide pore transit time.

A software signal analysis algorithm may then be utilized which converts the binned radiation intensity signal to a sequence corresponding to a particular nucleotide. Combination and alignment of four individual nucleotide sequences (where one of the four nucleotides in each sequence is labeled) allows construction of the complete nucleic acid sequence via a specifically designed computer algorithm.

The pore may be labeled with one or more donor labels in the form of quantum dots, metal nanoparticles, nano diamonds or fluorophores. The pore may be illuminated by monochromatic laser radiation. The monochromatic laser radiation may be focused to a diffraction limited spot exciting the quantum dot pore labels. As the labeled nucleic acid (e.g., labeled with an acceptor label in the form of a fluorophore) is translocated through the nanopore, the pore donor label (also “pore label” or “donor label”) and a nucleotide acceptor label come into close proximity with one another and participate in a FRET (Forster resonance energy transfer) energy exchange interaction between the pore donor label and nucleic acid acceptor label (Ha, T. et al, Proc. NatLAcad. Sci USA 93 (1996): 6264-6268). FRET is a non-radiative dipole-dipole energy transfer mechanism from a donor to acceptor fluorophore The efficiency of FRET may be dependent upon the distance between donor and acceptor as well as the properties of the fluorophores (Stryer, L. Annu Rev Biochem, 47 (1978): 819-846). A fluorophore may be any construct that is capable of absorbing light of a given energy and re-emitting that light at a different energy. Fluorophores include, e.g., organic molecules, rare-earth ions, metal nanoparticles, nanodiamonds and semiconductor quantum dots.

With respect to Quantum dots, due to the size dependent optical properties of quantum dots, the donor emission wavelength may be adjusted. This allows the spectral overlap between donor emission and acceptor absorption to foe adjusted so that the Forster radius for the FRET pair may be controlled. The emission spectrum for Quantum dots is narrow, (e.g., 25 nm Full width-half maximum—FWHM—is typical for individual quantum dots) and the emission wavelength is adjustable by size, enabling control over the donor label-acceptor label interaction distance by changing the size of the quantum dots. Another important attribute of quantum dots is their broad absorption spectrum, which allows them to be excited at energies that do not directly excite the acceptor label. The properties allow quantum dots of the properly chosen size to be used to efficiently transfer energy with sufficient resolution to excise individual labeled nucleotides as, after or before the labeled nucleotides, travel through a donor labeled pore.

Following a FRET energy transfer, the pore donor label may return to (be electronic ground slate and the nucleotide acceptor label can re-emit radiation at a lower energy. Where fluorophore labeled nucleotides are utilized, energy transferred from the fluorophore acceptor label results in emitted photons of the acceptor label. The emitted photons of the acceptor label may exhibit lower energy than the pore label emission. The detection system for fluorescent nucleotide labels may be designed to collect the maximum number of photons at the acceptor label emission wavelength while filtering out emission from a donor label (e.g., quantum dot donors) and laser excitation. The detection system counts photons from the labeled products as a function of time. Photon counts are burned into time intervals corresponding to the translocation time of, for instance, a product or flow of a plurality of products released in the same sequencing reaction step. Spikes in photon counts correspond to labeled products translocating across the pore. To sequence the nucleic acid, sequence information for a given product is determined by the pattern of spikes in photon counts as a function of time. An increase in photon counts is interpreted as a labeled product or plurality of products released inn the same sequencing reaction step.

Different pore labels exhibiting different spectral absorption maxima may be attached to a single pose. The nucleic acid may be modified with corresponding acceptor dye labeled products where each donor label forms FRET pairs with one acceptor labeled product (i.e. multi-color FRET). Products labeled specifically for each of the four nucleotides may contain a specific acceptor label which gets excited by one or more of the pore donor labels. The base of the pore may be illuminated with different color light sources to accommodate the excitation of the different donor labels. Alternatively, e.g., where Quantum dots are used its donor labels, the broad absorption spectra characteristic of Quantum dots may allow for a single wavelength light source to sufficiently illuminate/excitate the different donor labels which exhibit different spectral absorption maxima.

A single pore donor label (e.g., a single Quantum dot) may be suitable for exciting one nucleic acid acceptor label. For example, four different pore donor labels may be provided where each donor label can excite one of four different nucleic acid acceptor labels resulting in the emission of four distinct wavelengths. A single pore donor label (e.g., a single Quantum dot) may be suitable for exciting two or more nucleic acid acceptor labels that have similar absorption spectra overlapping with the donor label emission spectrum and show different emission spectra (i.e. different Stoke's shifts), where each acceptor label emits light at a different wavelength after excitation by the single donor label. Two different pore donor labels (e.g., two Quantum dots having different emission or absorption spectra) may be suitable for exciting four nucleic acid acceptor labels having different emission or excitation spectra, which each emit light at different wavelengths. One donor label or Quantum dot may be capable of exciting two of the nucleic acid acceptor labels resulting in their emission of light at different wavelengths, and the other Quantum dot may be capable of exciting the other two nucleic acid acceptor labels resulting in their emission of light at different wavelengths. The above arrangements provide clean and distinct wavelength emissions from each nucleic acid acceptor label for accurate detection.

For accumulation of the raw signal data where a multi-color FRET interaction is utilized, the emission wavelength of the four different acceptor labels may be filtered and recorded as a function of time and emission wavelength, which results in a direct read-out of sequence information. A nucleotide acceptor label may be in the form of a quencher which may quench the transferred energy. In the ease of a quenching nucleotide label, radiation emission from the pore donor label will decrease when a labeled nucleotide is in proximity to the donor label. The detection system tor quenching pore labels is designed to maximize the radiation collected from the pore labels, while filtering out laser excitation radiation. For a quenching label, a decrease in photon counts of the pore label, such as a quantum dot, is interpreted as a labeled nucleotide.

### Definitions

“Amplicon” means the product of a polynucleotide amplification reaction; that is, a clonal population of polynucleotides, which may be single stranded or double stranded, which are replicated from one or more starting sequences. The one or more starting sequences may be one or more copies of the same sequence, or they may be a mixture of different sequences that contain a common region that is amplified, for example, a specific exon sequence present in a mixture of DNA fragments extracted from a sample. Preferably, amplicons are formed by the amplification of a single starting sequence. Amplicons may be produced by a variety of amplification reactions whose products comprise replicates of the one or more starting, or target, nucleic acids. In one aspect, amplification reactions producing amplicons are “template-driven” in that base pairing of reactants, either nucleotides or oligonucleotides, have complement's in a template polynucleotide that are required for the creation of reaction products. In one aspect, template-driven reactions are primer extensions with a nucleic acid polymerase or oligonucleotide ligations with a nucleic acid ligase. Such reactions include, but are not limited to, polymerase chain reactions (PCRs), linear polymerase reactions, nucleic acid sequence-based amplification (NASBAs), rolling circle amplifications, and the like, disclosed in the following references that are incorporated herein by reference: Mullis et al, U.S. Pat. Nos. 4,683,195; 4,965,188; 4,683,202; 4,800,159 (PCR): Gelfand et al, U.S. Pat. No. 5,210,015 (real-time PCR with “taqman” probes); Wittwer et al, U.S. Pat. No. 6,174,670; Kacian et al, U.S. Pat. No. 5,399.491 (“NASBA”); Lizardi, U.S. Pat. No. 5,854,033; Aono et al, Japanese patent publ. JP 4-262799 (rolling circle amplification); and the like. In one aspect, amplicons of the invention are produced by PCRs. As used herein, the term “amplifying” means performing an amplification reaction. A “reaction mixture” means a solution containing all the necessary reactants for performing a reaction, which may include, but not be limited to, buffering agents to maintain pH at a selected level during a reaction, salts, co-factors, scavengers, and the like. A “solid phase amplicon” means a solid phase support, such as a particle or bead, having attached a clonal population of nucleic acid sequences, which may have been produced by a process such as emulsion PCR, or like technique.

“Microfluidics device” means an integrated system of one or more chambers, ports, and channels that are interconnected and in fluid communication and designed for carrying out an analytical reaction or process, either alone or in cooperation with an appliance or instrument that provides support functions, such as sample introduction, fluid and/or reagent driving means, temperature control, detection systems, data collection and/or integration systems, and the like. Microfluidics devices may further include valves, pumps, and specialized functional coatings on interior walls, e.g. to prevent adsorption, of sample components or reactants, facilitate reagent movement by eleclroosmosis, or the like. Such devices are usually fabricated in or as a solid substrate, which may be glass, plastic, or other solid polymeric materials, and typically have a planar format for ease of detecting and monitoring sample and reagent movement, especially via optical or electrochemical methods. Features of a microfluidic device usually have cross-sectional dimensions of less than a few hundred square micrometers and passages typically have capillary dimensions, e.g. having maximal cross-sectional dimensions of from about 500 μm to about 0.1 μm. Microfluidics devices typically have volume capacities in the range of front 1 μL to a few nL., e.g. 10-100 nL. The fabrication and operation of microfluidics devices are well-known in the art as exemplified by the following references that are incorporated by reference: Ramsey, U.S. Pat. Nos. 6,001,229; 5,858,195; 6,010,607; and 6,033,546; Soane et al, U.S. Pat. Nos. 5,126,022 and 6,054,034; Nelson et al, U.S. Pat. No. 6,613,525; Maher et al, U.S. Pat. No. 6,399,952; Ricco et al. International patent publication WO 02/24322; Bjornson et al, International patent publication WO 99/19717; Wilding et al, U.S. Pat. Nos. 5,587,128; 5,498,392; Sia et al. Electrophoresis, 24; 3563-3576 (20O3); Unger et al, Science, 288: 113-116 (2000); Enzelberger et al, U.S. Pat. No. 6,960,437.

“Microwell,” which is used interchangeably with “reaction chamber,” means a special ease of a “reaction confinement region,” that is, a physical or chemical attribute of a solid substrate that permit the localization of a reaction of interest. Reaction confinement regions may be a discrete region of a surface of a substrate that specifically binds an analyte of interest, such as a discrete region with oligonucleotides or antibodies covalently linked to such surface. Usually reaction confinement regions are hollows or wells having well-defined shapes and volumes which are manufactured into a substrate. These latter types of reaction confinement regions are referred to herein as microwells or reaction chambers, and may be fabricated using: conventional microfabrication techniques, e.g. as disclosed in the following references: Doering and Nishi, Editors, Handbook of Semiconductor Manufacturing Technology. Second Edition (CRC Press, 2007); Saliterman, Fundamentals of BioMEMS and Medical Microdevices (SPIE Publications, 2006); Elwenspoek et al, Silicon Micromachining (Cambridge University Press, 2004); and the like. Preferable configurations (e.g. spacing, shape and volumes) of microwells or reaction chambers are disclosed in Rothberg et al, U.S. patent publication 2009/0127589; Romberg et al, U.K. patent application GB24611127, which are incorporated by reference. Microwells may have square, rectangular, or octagonal cross sections and be arranged as a rectilinear array on a surface. Microwells may also have hexagonal cross sections and be arranged as a hexagonal array, which permit a higher density of microwells per unit area in comparison to rectilinear arrays. Exemplary configurations of microwells are as follows: In some embodiments, the reaction chamber array comprises 102, 103, 104, 105, or 106 reaction chambers. Briefly, in one embodiment microwell arrays may be fabricated as follows: After the semiconductor structures of a sensor array are formed, the microwell structure is applied to such structure on the semiconductor die. That is, the microwell structure can be formed right on the die or it may be formed separately and then mounted onto the die, either approach being acceptable. To form the microwell structure on the die, various processes may be used. For example, the entire die may be spin-coated with, for example, a negative photoresist such as Microchem's SU-8 2015 or a positive resist/polyimide such as HD Microsystems HD8820, to the desired height of the microwells. Alternatively, multiple layers of different photoresists may be applied or another form of dielectric material may be deposited. Various types of chemical vapor deposition may also be used to build up a layer of materials suitable for microwell formation therein. In one embodiment, microwells are formed in a layer of tetra-methyl-ortho-silicate (TEOS).

“Polymerase chain reaction, ” or “PCR,” means a reaction for the in vitro amplification of specific DNA sequences by the simultaneous primer extension of complementary strands of DNA. In other words, PCR is a reaction for making multiple copies or replicates of a target nucleic acid flanked by primer binding sites, such reaction comprising one or more repetitions of the following steps: (i) denaturing the target nucleic acid, (ii) annealing primers to the primer binding sites, and (iii) extending the primers by a nucleic acid polymerase in the presence of nucleoside triphosphates. Usually, the reaction is cycled through different temperatures optimized for each step in a thermal cycler instrument. Particular temperatures, durations at each step, and rates of change between steps depend on many factors well-known to those of ordinary skill its the art, e.g. exemplified by the references; McPherson et al, editors, PCR: A Practical Approach and PCR2: A Practical Approach (IRL Press, Oxford, 1991 and 1995, respectively). For example, in a conventional PCR using Taq DNA polymerase, a double stranded target nucleic acid may be denatured at a temperature >90° C., primers annealed at a temperature in the range 50-75° C., and primers extended at a temperature in the range 72-78° C. The term “PCR” encompasses derivative forms of the reaction, including but not limited to, RT-PCR, real-time PCR, nested PCR, quantitative PCR, multiplexed PCR, and the like. Reaction volumes range from a few hundred nanoliters, e.g. 200 nL, to a few hundred μL., e.g. 200 μL. “Reverse transcription PCR.” or “RT-PCR,” means a PCR that is preceded by a reverse transcription reaction that converts a target RNA to a complementary single stranded DNA, which is then amplified, e.g. Tecott et al, U.S. Pat. No. 5,168,038, which patent is incorporated herein by reference. “Real-time PCR” means a PCR for which the amount of reaction product, i.e. amplicon, is monitored as the reaction proceeds. There are many forms of real-time PCR that differ mainly in the detection chemistries used for monitoring the reaction product, e.g. Gelfand et al, U.S. Pat. No. 5,210,015 (“taqman”): Wittwer et al, U.S. Pat. Nos. 6,174,670 and 6,569,627 (intercalating dyes); Tyagi et al, U.S. Pat. No. 5,925,517 (molecular beacons); which patents are incorporated herein by reference. Detection chemistries for real-time PCR are reviewed in Mackay et al, Nucleic Acids Research, 30: 1292-1305 (2002), which is also incorporated herein by reference. “Nested PCR” means a two-stage PCR wherein the amplicon of a first PCR becomes the sample for a second PCR using a new set of primers, at least one of which binds to an interior location of the first amplicon. As used herein, “initial primers” in reference to a nested amplification reaction mean the primers used to generate a first amplicon, and “secondary primers” mean the one or more primers used to generate a second, or nested, amplicon. “Multiplexed PCR” means a PCR wherein multiple target sequences (or a single target sequence and one or more reference sequences) are simultaneously carried out in the same reaction mixture, e.g. Bernard et al. Anal. Biochem., 273: 221-228 (1999) (two-color real-time PCR). Usually, distinct sets of primers are employed, for each sequence being amplified. Typically, the number of target sequences in a multiplex PCR is in the range of from 2 so 50, or from 2 to 40, or from 2 to 30, “Quantitative PCR” means a PCR designed to measure the abundance of one or more specific target sequences in a sample or specimen. Quantitative PCR includes both absolute quantitation and relative quantitation of such target sequences. Quantitative measurements are made using one or more reference sequences or internal standards that may be assayed separately or together with a target sequence. The reference sequence may be endogenous or exogenous to a sample or specimen, and in the latter case, may comprise one or more competitor templates. Typical endogenous reference sequences include segments of transcripts of the following genes: β-actin, GAPDH, β₂-microglobulin, ribosomal RNA, and the like. Techniques for quantitative PCR are well-known to those of ordinary skill in the art, as exemplified in the following references that are incorporated by reference: Freeman et al, Biotechniques, 26: 112-126 (1999); Becker-Andre et al Nucleic Acids Research, 17: 9437-9447 (1989); Zimmerman et al, Biotechniques, 21: 268-279 (1996); Diviacco et al, Gene, 122: 3013-3020 (1992): Becker-Andre et al. Nucleic Acids Research, 17: 9437-9446 (1989); and the like.

“Polynucleotide” or “oligonucleotide” are used interchangeably and each mean a linear polymer of nucleotide monomers. “Template” refers to a polynucleotide that participates in a reaction where such polynucleotide or its complement is partially or fully replicated, usually in an enzymatic reaction, such as a DNA polymerase extension reaction. Monomers making up polynucleotides and oligonucleotides are capable of specifically binding to a natural polynucleotide by way of a regular pattern, of monomer-to-monomer interactions, such as Watson-Crick type of base pairing, base stacking, Hoogsteen or reverse Hoogsteen types of base pairing, or the like. Such monomers and their internucleosidic linkages may be naturally occurring or may be analogs thereof, e.g. naturally occurring or non-naturally occurring analogs. Non-naturally occurring analogs may include PNAs, phosphorothioate internuceosidic linkages, bases containing linking groups permitting the attachment of labels, such as fluorophores, or haptens, and the like. Whenever the use of an oligonucleotide or polynucleotide requires enzymatic processing, such as extension by a polymerase, ligation by a ligase, or the like, one of ordinary skill would understand that oligonucleotides or polynucleotides in those instances would not contain certain analogs of internucleosidic linkages, sugar moities, or bases at any or some positions. Polynucleotides typically range in size from a few monomeric waits, e.g. 5-40, when they are usually referred to as “oligonucleotides,” to several thousand monomeric units. Whenever a polynucleotide or oligonucleotide is represented by a sequence of letters (upper or lower case), such as “ATGCCTG.” it will be understood that the nucleotides are in 5′→3′ order from left to right and that “A” denotes deoxyadenosine, “C” denotes deoxycytidine, “G” denotes deoxyguanosine, and “T” denotes thymidine, “I” denotes deoxyinosine, “U” denotes uridine, unless otherwise indicated or obvious from context. Unless otherwise noted the terminology and atom numbering conventions will follow those disclosed in Strachan and Read, Human Molecular Genetics 2 (Wiley-Liss, New York, 1999). Usually polynucleotides comprise the four natural nucleosides (e.g. deoxyadenosine, deoxycytidine, deoxyguanosine, deoxythymidine for DNA or their ribose counterparts for RNA) linked by phosphodiester linkages; however, they may also comprise non-natural nucleotide analogs, e.g. including modified bases, sugars, or internucleosidic linkages. It is clear to those skilled in the art that where an enzyme has specific oligonucleotide or polynucleotide substrate requirements for activity, e.g. single stranded DNA, RNA/DNA duplex, or the like, then selection of appropriate composition for the oligonucleotide or polynucleotide substrates is well within the knowledge of one of ordinary skill, especially with guidance from treatises, such as Sambrook et al. Molecular Cloning, Second Edition. (Cold Spring Harbor Laboratory, New York, 1989), and like references.

“Pore” or “nanopore” refers to any constriction or limited volume that restricts the passage of binding and receptor components. Pore includes apertures, holes, and channels. Channel includes, among others, trough, groove, or any conduit for passage of the components in the mixture to be detected its the detection region. The pore or channel dimensions can depend on the detection mode used. However, the size of the pore is at least such that it permits translocation of the unbound aid bound components for detection. Thus, in some embodiments, the pore or channel can be a nanopore having a diameter or channel dimension, of about 100 nm or less, about 50 nm or less, about 20 nm or less, about 10 nm or less, about 5 nm or less, or about 2 nm or less, to about 0.5 nm. In some embodiments, the pore is of a dimension sufficient to limit: the translocation through the pore to a single kind of resistive-pulse label

“Primer” means an oligonucleotide, either natural or synthetic that is capable, upon forming a duplex with a polynucleotide template, of acting as a point of initiation of nucleic acid synthesis and being extended from its 3′ end along the template so that an extended duplex is formed. Extension of a primer is usually carried out with a nucleic acid polymerase, such as a DNA or RNA polymerase, the sequence of nucleotides added in the extension process is determined by the sequence of the template polynucleotide. Usually primers are extended by a DNA polymerase. Primers usually have a length in the range of from 14 to 40 nucleotides, or in the range of from 18 to 36 nucleotides. Primers are employed in a variety of nucleic amplification reactions, tor example, linear amplification reactions using a single primer, or polymerase chain reactions, employing two or more primers. Guidance for selecting the lengths and sequences of primers for particular applications is well known to those of ordinary skill in the art, as evidenced by the following references that are incorporated by reference: Dieffenbach, editor, PCR Primer: A Laboratory Manual, 2^{nd} Edition (Cold Spring Harbor Press, New York, 2003).

“Rolling circle amplification,” or “RCA” means a process in which a primer is annealed to a circular DNA molecule and extended by a DNA polymerase in the presence of nucleoside triphosphates to produce an extension product that contains multiple copies of the complementary sequence of the circular DNA molecule.

“Translocation” refers to movement of the component through the pore for detection in the detection region. In some embodiments, the translocation is directed translocation where a force is applied to move the component preferentially in a specified direction. The force can be any force, such as electromotive gradients, pressure gradients, concentration gradients, temperature gradients, osmotic gradients, or any other suitable force that can directionally transport the components in the mixture through the pore.

What is claimed is:

1. A method of determining a nucleotide sequence of a target polynucleotide, the method comprising the steps of:
(a) generating a plurality of amplicons from the target polynucleotide, each amplicon comprising multiple copies of a fragment of the target polynucleotide;
(b) forming an array of amplicons on a nanopore array;
(c) identifying a sequence of at least a portion of each fragment in the amplicons by repeatedly forming sequencing reaction products thereon labeled with on or more resistive-pulse labels and eluting the labeled sequencing reaction products through the nanopore array, where the number and type of sequencing reaction product for each amplicon is determined by a resistive-pulse signal; and
(d) reconstructing the nucleotide sequence of the target polytnucleotide from the identities of the sequences of the portions of fragments of the amplicons.

2. The method of claim 1 wherein said sequencing reaction products include polymerase extension products, pyrophosphate groups released in an extension, reaction, released labels on bases of incorporated nucleoside triphosphates, and released 3′ blocking groups.

3. The method of claim 2 wherein said sequencing reaction products are pyrophosphate groups released in an extension reaction.

4. The method of claim 2 wherein said step of generating a plurality of amplicons includes carrying out bridge PCRs on said nanopore array with said fragments of said target polynucleotide.

5. The method of claim 2 wherein said nanopore array is formed in a solid substrate.

6. The method of claim 5 wherein said nanopore array is comprised of hybrid nanopores each comprising protein nanopore disposed in a solid phase nanopore fabricated in said solid substrate.

7. A method of determining a nucleotide sequence of a target polynucleotide, the method comprising the steps of:
(a) generating a plurality of amplicons from the target polynucleotide, each amplicon comprising multiple copies of a fragment of the target polynucleotide;
(b) forming an array of amplicons on a nanopore array having labeled nanopores each with a FRET donor moiety,
(c) identifying a sequence of at least a portion of each fragment its the amplicons by repeatedly forming sequencing reaction products thereon labeled with one or more optical labels and one or more resistive-pulse labels and eluting the labeled sequencing reaction products through the labeled nanopores of the nanopore array, wherein each optical label is capable of accepting FRET energy from the FRET donor moiety and wherein the number and type of sequencing reaction product for each amplicon is determined from correlated signals comprising a FRET signal generated by an optical label and a resistive-pulse signal; and
(d) reconstructing the nucleotide sequence of the target polynucleotide from the identities of the sequences of the portions of fragments of the amplicons.

8. The method of claim 7 wherein said sequencing reaction products include polymerase extension, products, pyrophosphate groups released in an extension reaction, released labels on bases of incorporated nucleoside triphosphates, and released 3′ blocking groups.

9. The method of claim 8 wherein said sequencing reaction products are pyrophosphate groups released in an extension reaction.

10. The method of claim 8 wherein said step of generating a plurality of amplicons includes carrying out bridge PCRs on said nanopore array with said fragments of said target polynucleotide.

11. The method of claim 7 wherein said FRET donor moiety is a quantum dot.

12. A method of determining a nucleotide sequence of a target polynucleotide, the method comprising the steps of:
forming at least one amplicon on a surface of or in layer on a nanopore array, the amplicon comprising at least one fragment of the target polynucleotide; and
identifying a sequence of at least a portion of each fragment in each amplicon by repeatedly forming sequencing reaction products thereon labeled with one or more resistive-pulse labels and editing the labeled sequencing reaction products through the nanopore array.

13. The method of claim 12 further including the step of reconstructing the nucleotide sequence of said target polynucleotide from the identities of the sequences of the portions of fragments of said amplicons.

14. The method of claim 12 wherein said amplicons each comprise a fragment of the target polynucleotide completed with sequencing primers and DNA polymerases and wherein said step of identifying includes identifying a sequence of at least a portion of each fragment in each amplicon by repeatedly delivering resistive-pulse labeled nucleoside triphosphates to the amplicons so that primers therein are extended releasing one or more resistive-pulse labeled pyrophosphates that traverse the nanopore array.
